(19) United States
(12) Patent Application Publication
(10) Pub. No.: US 2008/0103701 A1
(43) Pub. Date: May 1, 2008

(54) AUTOMATIC SIGNAL PROCESSOR DESIGN SOFTWARE SYSTEM

(75) Inventors: Weimin Xiao, Hoffman Estates, IL (US); Di-An Hong, Inverness, IL (US); Magdi A. Mohamed, Schaumburg, IL (US); Chi Zhou, Vernon Hills, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/554,651

(22) Filed: Oct. 31, 2006

(51) Int. Cl. G06F 19/00; G06F 15/18

(52) U.S. Cl. 702/20; 706/6

(57) ABSTRACT

Software (100, 600, 1000, 1100) for automatically designing and optimizing signal processing networks (e.g., 200, 700, 800, 900) is provided. The software use genetic programming e.g., gene expression programming in combination with numerical optimization, e.g., a hybrid differential evolution/genetic algorithm numerical optimization to design and optimize signal processing networks. According to certain embodiments signal processing elements (1500, 1800) the character of which is qualitatively changed by changing configuration parameters are used in designing and optimizing the signal processing

### FIELD OF THE INVENTION

The present invention relates generally to signal processing.

### BACKGROUND

Signal processing is a basic component of a wide variety of electronic equipment. Signal processing is used to condition signals received from a variety of detectors, sensors and transducers. Signal processing is used in a myriad of technical application including wireless voice and data communication, medical diagnostic, and engineering and scientific instruments.

Extracting information from signals that are highly degraded by noise and/or distortion is challenging. Also, extracting information from signals that are not well understood, e.g., particular signals that are tapped using a brain computer interface, is challenging. Traditional digital signal processing techniques may not suffice. Moreover, in such challenging applications it is not always apparent how to make a signal processing network that will successfully extract desired information from signals.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a flowchart of a program for automatically designing and optimizing a signal processing network;

FIG. 2 is an example of signal processing network that could be designed by the program shown in FIG. 1;

FIG. 3 is a tree diagram representation of the signal processing network shown in FIG. 2;

FIG. 4 is liner chromosome array encoding the signal processing network shown in FIG. 2 and represented in FIG. 3;

FIG. 5 is a flowchart of sub-program for decoding linear chromosome array representations of signal processing networks;

FIG. 6 is a flowchart of a sub-program for determining the length of sub-tree encoding portions of linear chromosomes and checking if linear chromosomes encode valid signal processing networks;

FIGS. 7-9 are further examples of signal processing networks that could be designed by the program shown in FIG. 1;

FIG. 10 is a flowchart for a sub-program for automatically optimizing component values, settings and/or control parameters that is used in the program shown in FIG. 1;

FIG. 11 is a flowchart of a sub-program for evaluating the output of a signal processing network represented in a chromosome array using node-child node associations generated by the sub-program shown in FIG. 5.;

FIG. 12 is block diagram illustrating a system of using the program shown in FIG. 1 in a supervised training methodology;

FIG. 13 is a block diagram illustrating a system of using the program shown in FIG. 1 in an indirectly supervised training methodology;

FIG. 14 is a block diagram illustrating a system of using the program shown in FIG. 1 in an unsupervised training methodology;

FIG. 15 is a block diagram of a highly versatile Q-filter that can be used in signal processing systems designed by the program shown in FIG. 1 along with a signal scaler and biaser;

FIG. 16 is a flowchart of the operation of the fast Q-filter;

FIG. 17 graphically illustrates a sliding window indirect insertion sort that is used in the Q-filter

FIGS. 18-19 illustrate how signal samples and filter parameters are reordered by the fast Q-filter;

FIG. 20 is a flowchart of a sliding window indirect insertion sort that is used by the fast Q-filter;

FIG. 21 is a first signal plot showing an unfiltered signal along with a filtered signal obtained by filtering the unfiltered signal with a fast Q-filter configured to emulate an erosion filter;

FIG. 22 is a second signal plot showing the unfiltered signal along with a filtered signal obtained by filtering the unfiltered signal with a fast Q-filter configured to emulate a dilation filter;

FIG. 23 is a third signal plot showing the unfiltered signal along with one filtered signal obtained by filtering the unfiltered signal with two fast Q-filters configured to emulate an opening filter and one filtered signal obtained by filtering with a fast Q-filter configured to function as an averaging filter;

FIG. 24 is a block diagram of a configurable, adaptive signal Q-aggregator that can be used in signal processing systems designed by the program shown in FIG. 1;

FIG. 25 is a surface plot showing the input-output relation of the Q-aggregator when configured to emulate an multi-valued logic AND gate;

FIG. 26 is a surface plot showing the input-output relation of the Q-aggregator when configured to emulate an multi-valued logic OR gate;

FIG. 27 is a surface plot showing the input-output relation of the Q-aggregator when configured to emulate a signal averager;

FIG. 28 is a block diagram of a computer that can be used to execute the programs shown in FIGS. 1, 5, 6, 10, 11, 16 and 20 according to embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to systems for designing signal processing systems. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of designing signal processing systems described herein. The non-processor circuits may include, but are not limited to, a radio receiver, a radio transmitter, signal drivers, clock circuits, power source circuits, and user input devices. As such, these functions may be interpreted as steps of a method to design signal processing systems. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

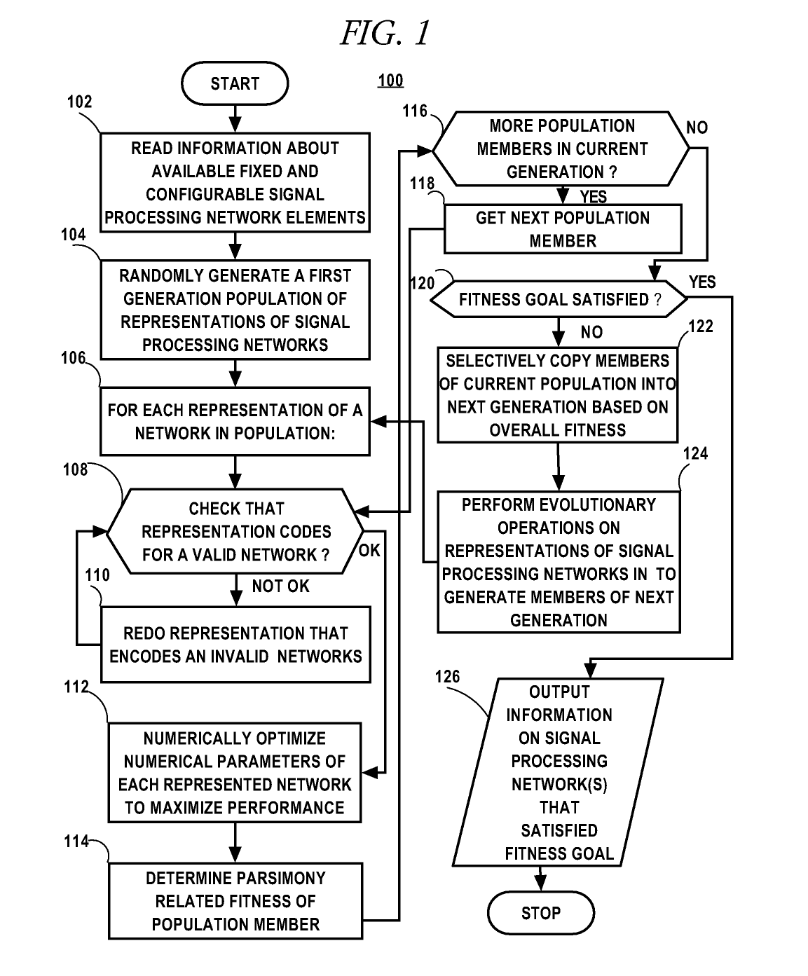

FIG. 1 is a flowchart of a program 100 for automatically designing and optimizing a signal processing network. The program 100 uses Genetic Programming, e.g., Gene Expression Programming in combination with a numerical optimization method, e.g., a Genetic Algorithm/Differential Evolution hybrid to design and optimize signal processing networks. In block 102 a list of available fixed and configurable network elements is read in. The network elements can include known types of discrete elements such as capacitors, inductors, diodes, resistors, known type of more complicated elements such as Finite Impulse Response (FIR) filters, Infinite Impulse Response (IIR) filters, decimators, delays, subtractors, adders, Multiply and Accumulate (MAC) signal processors, or newly invented signal processing elements. Examples of known signal processing blocks are the built-in blocks of Simulink® produced by Mathworks of Natick, Mass. Examples of newly invented signal processing elements that can be used for building the signal processing network are Q-filters, fast Q-filters and Q-aggregators. Q-filters are covered in a co-pending patent application entitled “Method and Apparatus for Digital Signal Filtering”, Ser. No. 10/854,836 by Magdi Mohamed et al. Fast Q-filters are covered in a co-pending patent application entitled “Fast Q-Filter”, Ser. No. ______ (Docket No. CML02826T) by Magdi Mohamed et al. Q-aggregators are covered in a co-pending patent application entitled “Method and Apparatus for Signal and Data Aggregation” Ser. No. ______ (Docket No. CML025829T) by Magdi Mohamed et al. Q-filters and fast Q-filters are versatile filters that can be reconfigured by changing a set of densities and a nonlinearity control parameter. The fast Q-filter is a power and/or computer resource efficient analog of a Q-filter. Q-aggregators are versatile configurable signal combiners that can emulate a continuum of aggregation functions between a infinite-level logic AND function and an infinite-level logic OR function. Fast Q-filters and Q-aggregators are discussed in more detail below.

Referring again to FIG. 1 in block 104 a first generation of a population (set) of representations of signal processing networks is randomly generated. In generating signal processing networks, the program 100 selects signal processing elements and a place holder for the input signal from a list at random. Table 1 below includes information about examples of various signal processing elements and the place holder for the signal source that could be used by the program 100.

TABLE I

| Processor | Name | Arity | Cost | Window | Index |
|---|---|---|---|---|---|
| − | − | 2 | 1 | 0 | 1 |
| + | + | 2 | 1 | 0 | 2 |
| V | S | 0 | 0 | 0 | 3 |
| QF | QF1 | 1 | 15 | 15 | 4 |
| QF | QF2 | 1 | 30 | 30 | 5 |
| . . . | . . . | . . . | . . . | . . . | |
| QA | QA1 | 2 | 2 | 0 | N + 1 |
| QA | QA2 | 3 | 3 | 0 | N + 2 |
| . . . | . . . | . . . | . . . | . . . | |

In table I the first column identifies the type of signal processing element, or the input signal. QF stands for Q-filter or fast Q-filter, QA stands for Q-aggregator, V stands for the input signal, etc. The second column gives a unique name. The third column gives the number of inputs that each signal processing element has (arity). The fourth column gives a cost associated with each signal processing element. The cost is a measure of the added complexity associated with including the signal processing element in a signal processing network. Co-pending patent application Ser. No. 10/101,814 entitled “Gene Expression Programming Algorithm” by Weimin Xiao teaches a way to use the cost information in an overall fitness measure that also includes performance based fitness criteria in order to bias genetic programming software toward less complicated solutions. The technique can also be applied in the program 100 for designing signal processing networks.

The fifth column of Table I gives the window size that the signal processing element uses. Note that there are QF1 and QF2 which are distinguished by the window size. Also, different Q-filters can have the same window size. The sixth column of Table II gives an integer index used to identity each signal processing element or the signal source. Storing each population as a matrix of the integer indexes in which each row or column represent a population member or as a set of arrays or vectors of indexes, allows evolutionary operations such as one point crossover, two point crossover, and mutation to be performed at a reduced computational cost, thereby accelerating the program 100. Also, if such a representation is used, then the step of initially generating the first generation amounts to selecting indexes at random for inclusion in the matrix or array set representation of the population. Each array or vector or matrix row or column represents a single population member which is a signal processing network. Before continuing with a description of the operation the program 100 shown in FIG. 1, we first describe representations of signal processing networks that are used in the program 100 and the decoding and validation of such representations.

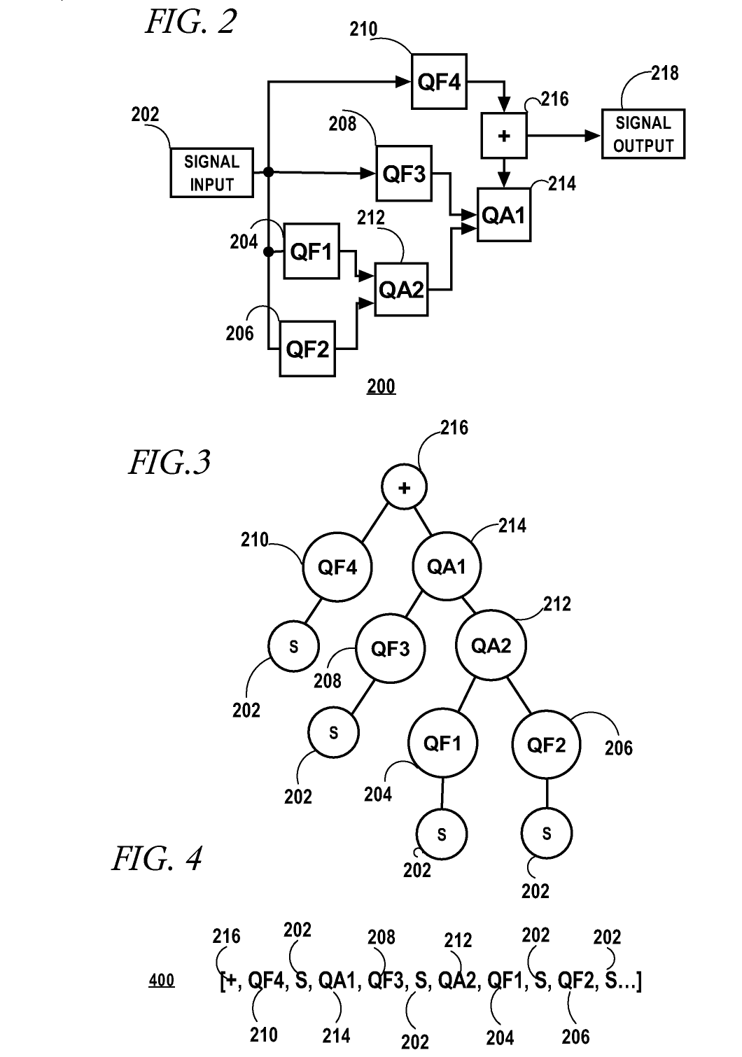

FIG. 2 shows an example of a signal processing system 200 that could be designed by the program shown in FIG. 1. The signal processing system 200 is also an example of signal processing system that could be initially randomly generated in block 104 of program 100. The signal processing system 200 has a signal input 202 connected to a first Q-filter 204, a second Q-filter 206, a third Q-filter 208, and a fourth Q-filter 210. Each Q-filter 204-210 is separately configured so as to process the signal received from the signal input 202 differently. Outputs of the first Q-filter 204 and the second Q-filter 206 are coupled to a second Q-aggregator 212. Outputs of the third Q-filter 208 and the second Q-aggregator 212 are input to a first Q-aggregator 214. Outputs of the first Q-aggregator 214 and the fourth Q-filter 210 are input to an adder 216. The output of the adder 216 is coupled to a signal output 218 of the signal processing system 200. Each Q-aggregator 212, 214 is also configured separately so that different functions can be performed.

FIG. 3 shows a tree diagram representation 300 of the signal processing system shown in FIG. 2. Note that the tree diagram 300 is rooted in the adder 216 which is the last signal processing element before the signal output 218. Note also that the leaf positions in the tree diagram include multiple appearances of the signal input 202 which is represented by ‘s’. There are at least two ways to encode the signal processing systems as population members-depth first and breadth first. A breadth first encoding of the signal processing system represented in FIGS. 2-3 is the array [+, QF4, QA1, S, QF3, QA2, S, QF1, QF2, S, S, . . . ]. In the context of gene expression programming this array is termed a chromosome and each element a gene or codon. The triple dot continuation symbol indicates that the actual array (or vector, row or column) length allowed to encode population members may exceed what is required to encode any given signal processing network. Although names are used in the preceding array for the purpose of illustration, as previously indicated, integer indexes may be used to accelerate evolutionary operations, because integer operations require less computer cycles and memory. The breadth first system of encoding is disclosed in the aforementioned co-pending patent application Ser. No. 10/101,814 entitled “Gene Expression Programming Algorithm”.

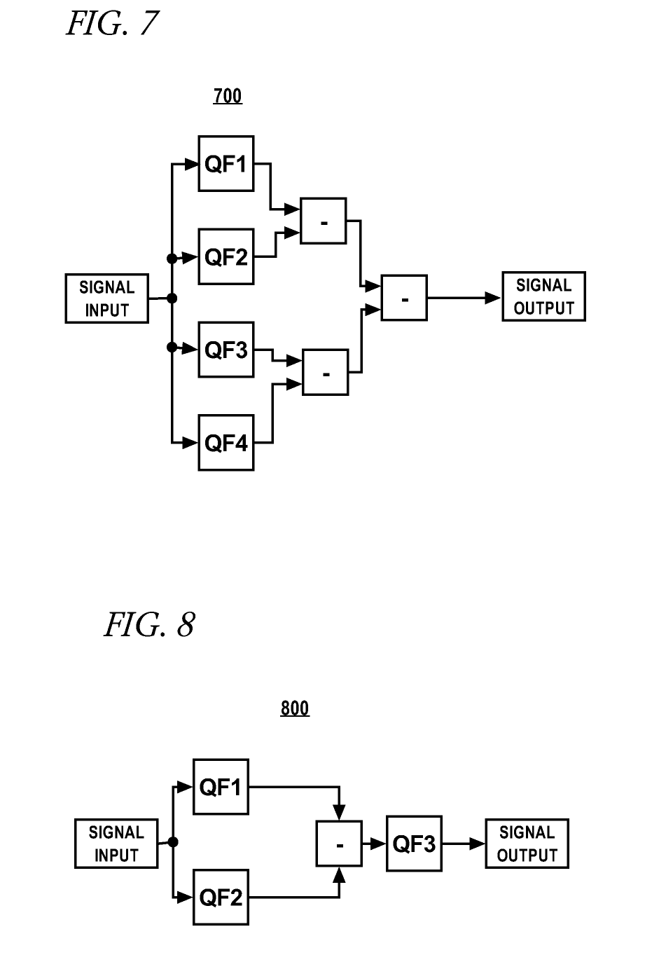

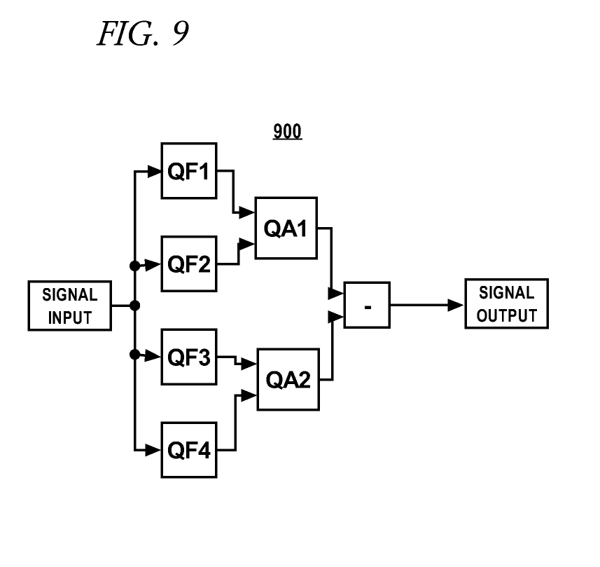

An alternative depth first encoding of the signal processing system represented in FIGS. 2-3 is the array [+, QF4, S, QA1, QF3, S, QA2, QF1, S, QF2, S . . . ]. The depth first encoding method tends to preserve substructure and make certain evolutionary operations less disruptive and may allow the program 100 to generate a suitable signal processing network faster. The depth first encoding is disclosed in co-pending patent application Ser. No. 11/073,828 filed Mar. 7, 2005 entitled “Gene Expression Programming With Enhanced Preservation Of Attributes Contributing To Fitness” by Chi Zhou et al. FIGS. 7-9 are further examples 700, 800, 900 of signal processing systems that could be designed or initially generated by the program 100. In the context of Gene Expression Programming, the arrays used to encode the network structure are called chromosomes, and each element of the arrays is called a gene. Note that although, in FIGS. 2,7-9 only a single input signal is processed, alternatively multiple distinct signals are processed to produce an output signal.

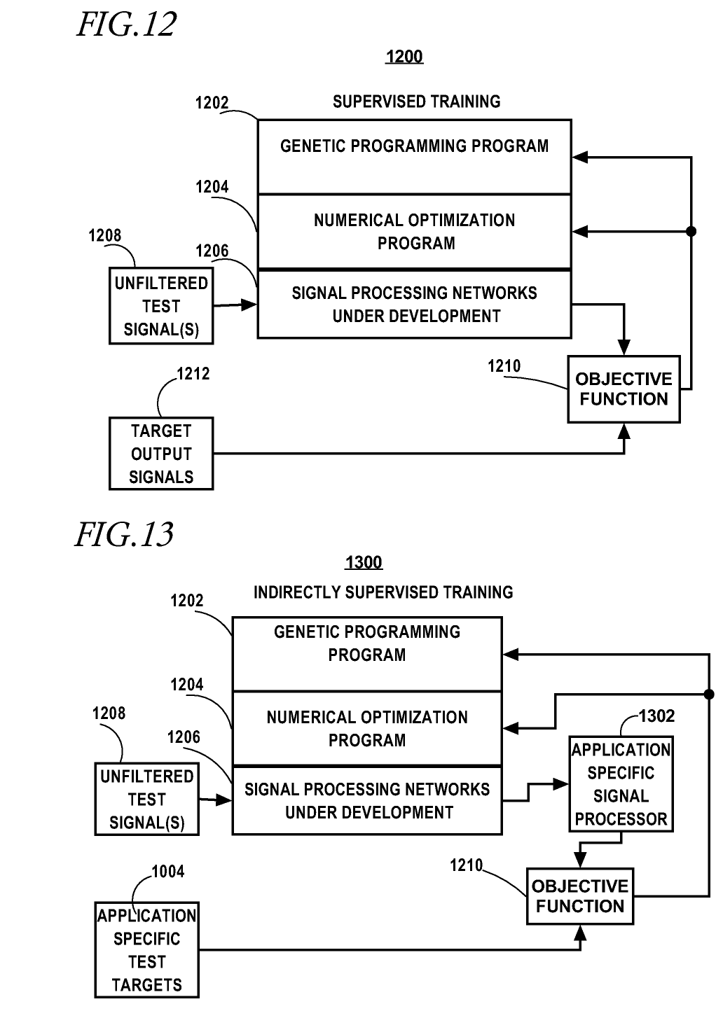

FIG. 4 shows the depth first liner chromosome array encoding 400 of the signal processing network 200 shown in FIG. 2 and represented in tree diagram form in FIG. 3. The reference numerals of the elements of the signal processing network 200 are used in FIG. 4 to illustrate the manner in which the tree representation of the signal processing network 200 shown in FIG. 3 is encoded in a depth-first manner. Although, alphanumeric symbols are used in the chromosome array shown in FIG. 12, in practice, integers may be used to represent each network element.

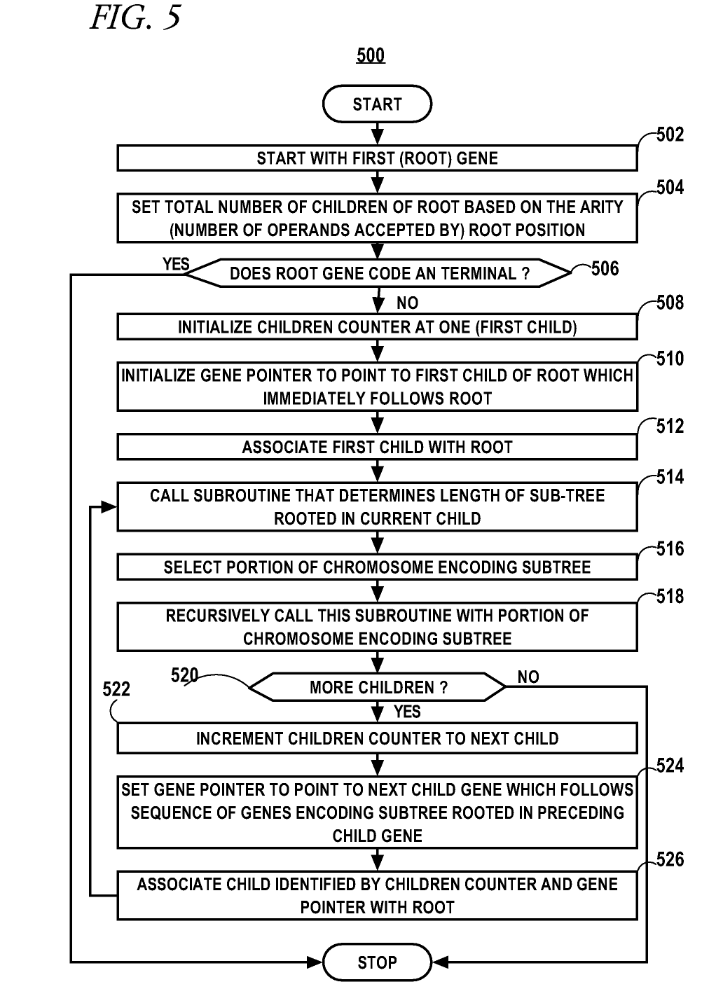

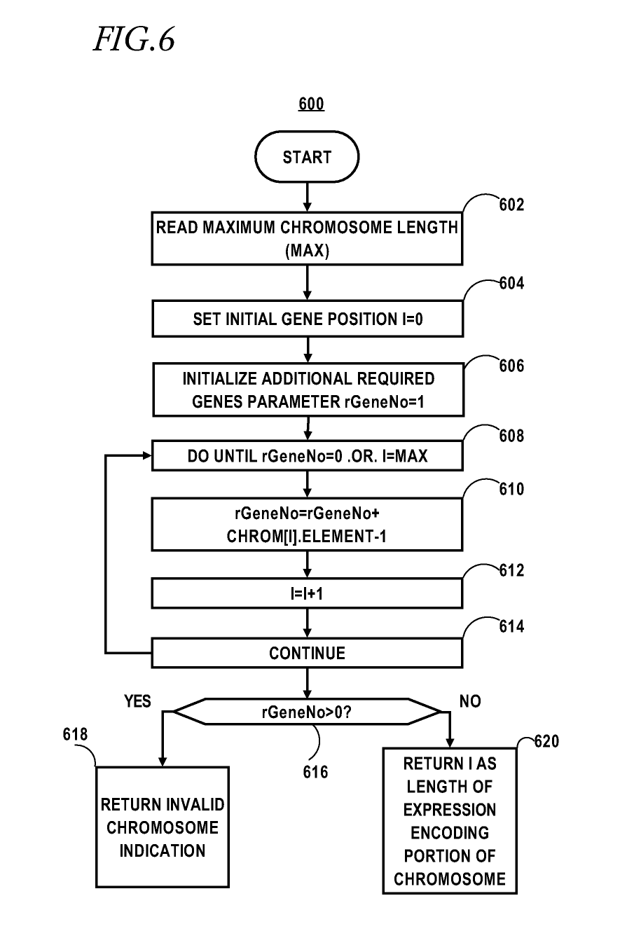

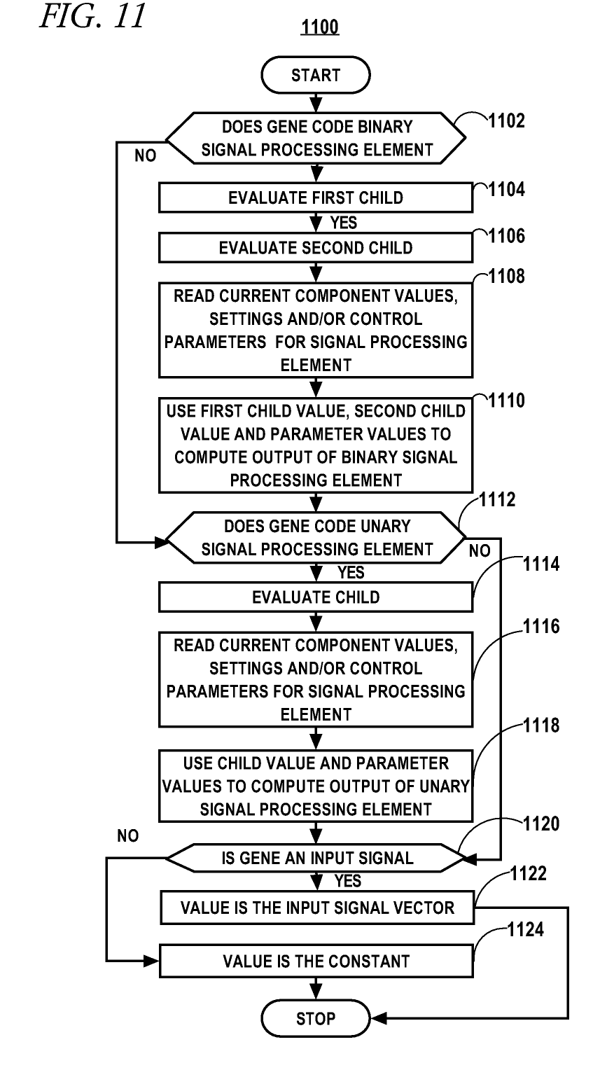

FIG. 5 is a flowchart of a sub-program 500 for decoding chromosome arrays such as shown in FIG. 12. Decoding implicitly determines a tree structure from a chromosome array by determining all of the parent-child relationships between genes in the chromosome array. Note that the sub-program 500 is a recursive sub-program that calls itself to handle each sub-tree of the tree represented in a chromosome array. When the sub-program 500 is initially invoked it receives a full chromosome array, when sub-program 500 calls itself recursively it receives a portion of the full chromosome that encodes a sub-tree representing a portion of a signal processing network. As indicated in block 502 the sub-program 500 starts with the root gene of the chromosome. When the program is called by itself it starts in block 502 with the first gene of a portion the chromosome representing a sub-tree. In block 504 the total number of children is set based on the arity of the signal processing element coded by the root gene. The arity or each signal processing element is pre-programmed and may be stored in a table, for example. Block 506 is a decision block the outcome of which depends on whether the root gene codes a terminal. A terminal is, for example, a constant or a signal input. A tree that has a terminal at the root is degenerate but may arise in certain instances, e.g., as a result of mutation in gene expression programming. If the root is a terminal the sub-program 500 terminates. On the other hand if the root is not a terminal the sub-program 500 proceeds to block 508, in which a children counter for the root node is initialized (e.g., with a value of one) to refer to the first child. Next in block 510 a gene pointer that takes on integer values referring to gene positions in the chromosome array is set to a value pointing to the first child of the root node, which immediately follows the root gene in the chromosome array. In block 512 the first child is associated with the root. In an object-oriented implementation of the sub-program 500 the association of the root node and its children nodes can be stored by assigning a reference to the child node to the root node. Alternatively, parent-child associations can be stored in a children array for each node, where each k^{th} element of the children array for a k^{th} child includes an integer index indicating the position of the child in the chromosome array. In block 514 a sub-program that determines the length (number of genes) of the sub-tree rooted by the current child is called. (When block 514 is reached the first time within sub-program 500, the current child is the first child.) The sub-routine can be called with a portion of the chromosome array starting with the current child. By way of example, in FIG. 3 the first child of the root node 216 is gene 210. (At this point in the interest of brevity we will dispense with naming the actual signal processing network elements that are encoded by the genes) Referring to FIG. 3, it is seen that the sub-tree rooted in gene 21 includes genes 210 and 202. One embodiment of the sub-program that is called in block 514 shown in FIG. 6 and described below. Note that the sub-program used in block 514 determines the sub-tree without the benefit of a previously established tree such as shown in FIG. 3. The sub-program only uses the linear chromosome representation shown in FIG. 4. After block 514, in block 516 the portion of the chromosome array (e.g., 400) that encodes the sub-tree is selected, and in block 518 the sub-program 500 recursively calls itself with the selected sub-tree. Block 520 is a decision block, the outcome of which depends on whether the root node has more children. Recall that the total number of children was set in block 504 based on the arity of the root node. If there are no more children, the sub-program 500 terminates. On the other hand, if there are more children, then in block 522 the children counter that was initialized in block 508 is incremented to the next child, and in block 524 the gene pointer is set to point to the next child which follows the sequence of genes encoding the sub-tree rooted in the preceding child. Block 524 uses the length of the sub-tree determined in block 514. By way of example, referring to FIGS. 11, 12. The next gene in the chromosome array 1200 following the genes 210, 202 that encode the sub-tree rooted in the first child 210 of the root 216 is the gene 214 for the second child of the root 216. In block 526 the child identified by the children counter and the gene pointer is associated with the root as another child of the root. Thereafter, the sub-program 500 loops back to block 514.

FIG. 6 is a flowchart of a sub-program 600 for determining the length of a portion of a chromosome array representing a tree or sub-tree. The method is disclosed in co-pending patent application Ser. No. 11/073,828 filed Mar. 7, 2005 entitled “Gene Expression Programming With Enhanced Preservation Of Attributes Contributing To Fitness” to Chi Zhou et al which is assigned in common with the present invention. The sub-program 600 also detects chromosomes arrays that encode incomplete signal processing networks and are therefore invalid. Invalid chromosomes may sometimes arise in gene expression programming (discussed below) for example by mutation. Certain parts of the sub-program 600 apply to checking entire chromosomes but are superfluous for checking sub-tree portions of chromosomes. In certain applications, such as the gene expression programming discussed below, the entire chromosome will be validated using the sub-program 600, before the sub-program 600 is used to determine the length of sub-tree encoding portions of the chromosome array. In block 602 a maximum chromosome length is read. The maximum chromosome length is a preprogrammed length that limits the size of signal processing networks encoded in the chromosome arrays. For practical purposes to control cost and power consumption, limits are set on the size of signal processing networks. In gene expression programming the maximum length is the size of population members (linear chromosome arrays). Block 602 is unnecessary for determining sub-tree size. In block 604 a gene position pointer is set to zero, which refers to the first gene of the chromosome array. In block 606 a variable ‘rGeneNo’ is initialized to one. The variable rGeneNo indicates a number of additional genes required to complete a tree or sub-tree encoding portion of a chromosome. As the sub-program 600 processes successive genes in a chromosome, the value of rGeneNo varies to reflect the number of appearances of the terminal genes required to provide enough input signals for all signal processing element genes up to the current (i^{th}) gene position.

Block 608 is the start of a program loop that is repeated until rGeneNo=0 (which happens when the end of an expression encoding portion of a chromosome or the end of a sub-tree has been reached) or until i=MAX (which happens when the end of the chromosome (e.g., population member array) has been reached. (If the end of the chromosome is reached without passing enough terminal genes to provide inputs for all signal processing element genes that have been encountered, an incomplete and therefore invalid signal processing network is encoded in the chromosome). For determining the length of sub-tree encoding portions of valid chromosomes the condition i=MAX is superfluous. In each pass through the program loop, in block 610, the rGeneNo variable is incremented by one less than the arity of the signal processing element represented by the i^{th} gene, and in block 612 the index i that points to successive genes is incremented by 1. Block 614 denotes the bottom of the program loop. Block 616 is a decision block, the outcome of which depends on whether, after the program loop has been exited, the value of the variable rGeneNo is greater than zero. A value greater than zero, indicates that more terminal genes, than are present in a chromosome, would be necessary to provide inputs for all of the signal processing element genes present in the chromosome. If it is determined in block 616 that the value of rGeneNo is greater than zero, the routine 600 proceeds to block 618 in which an invalid chromosome indication is returned. If on the other hand, it is determined in block 616 that rGeneNo is equal to zero, then the routine branches to block 620 in which the value of the index i is returned as the length (number of genes) of the network encoding portion of the chromosome that was processed by the routine 600 or the length of a sub-tree encoding portion of the chromosome. For determining the length of sub-tree encoding portions of known valid chromosomes decision block 616 is superfluous, as the sub-program 600 will always report the length of the sub-tree encoding portion. Alternatively, for determining the length of sub-trees I can be initialized to the position of the root of the sub-tree in the full chromosome array, and in block 620 the final value of I can be reported back as the last gene in the sub-tree encoding portion of the full chromosome.

Table II below illustrates the operation of the sub-program 600.

TABLE II

| Part of Chromosome to be | | Current | Required | |
|---|---|---|---|---|
| processed | I | Gene | Operands | RGeneNo |
| +, QF4, S, QA1, QF3, S, QA2, | 0 | + | 2 | 2 |
| QF1, S, QF2, S | | | | |
| QF4, S, QA1, QF3, S, QA2, QF1, | 1 | QF4 | 1 | 2 |
| S, QF2, S | | | | |
| S, QA1, QF3, S, QA2, QF1, S, | 2 | S | 0 | 1 |
| QF2, S | | | | |
| QA1, QF3, S, QA2, QF1, S, QF2, | 3 | QA1 | 2 | 2 |
| S | | | | |
| QF3, S, QA2, QF1, S, QF2, S | 4 | QF3 | 1 | 2 |
| S, QA2, QF1, S, QF2, S | 5 | S | 0 | 1 |
| QA2, QF1, S, QF2, S | 6 | QA2 | 2 | 2 |
| QF1, S, QF2, S | 7 | QF1 | 1 | 2 |
| S, QF2, S | 8 | S | 0 | 1 |
| QF2, S | 9 | QF2 | 1 | 1 |
| S | 10 | S | 0 | 0 |

In Table II the first column shows a portion of an exemplary chromosome (the depth first encoding of the signal processing network shown in FIG. 2) to be processed at the beginning of the program loop commenced in block 608, the second column indicates the value of the i variable at the start of the program loop, the third column shows the gene in the i^{th} position, the fourth column shows required operands for the i^{th} gene, and the fifth column shows the value of the rGeneNo variable after executing block 610. The chromosome could have been longer but the network encoding portion ends at the gene in the tenth position. When the gene 10 is reached the variable rGeneNo attains a value of zero and the program loop (blocks 608-614) is exited, whereupon the routine executes decision block 616.

Referring again to FIG. 1, block 106 is the top of a loop that processes each signal processing network represented in the population. In block 108 each population member is checked to ensure that it represents a valid population member. Sub-program 600 can be used for block 106. If it is determined in block 108 that a particular population member does not encode a valid signal processing network, then in block 110 the population member is redone. The population member can be redone by applying some evolutionary operation such as mutating one or more genes at random, or performing a circular shift of the genes, by regenerating a random replacement population member, or by replacing one or more signal processing element encoding gene with signal source genes, for example. After a population member is redone, the program loops back to block 108 to check the population member again.

After the population member has been redone, or if the population member passed the check performed in block 108 initially, the program 100 branches to block 112. In block 112 component values, settings and/or control parameters of the signal processing elements in the signal processing network are automatically optimized. Examples of sub-programs that can be used for block 112 include programs that implement direct search methods such as the Nelder-Mead algorithm, a Simulated Annealing Algorithm, a Genetic Algorithm, or a Differential Evolution algorithm for example.

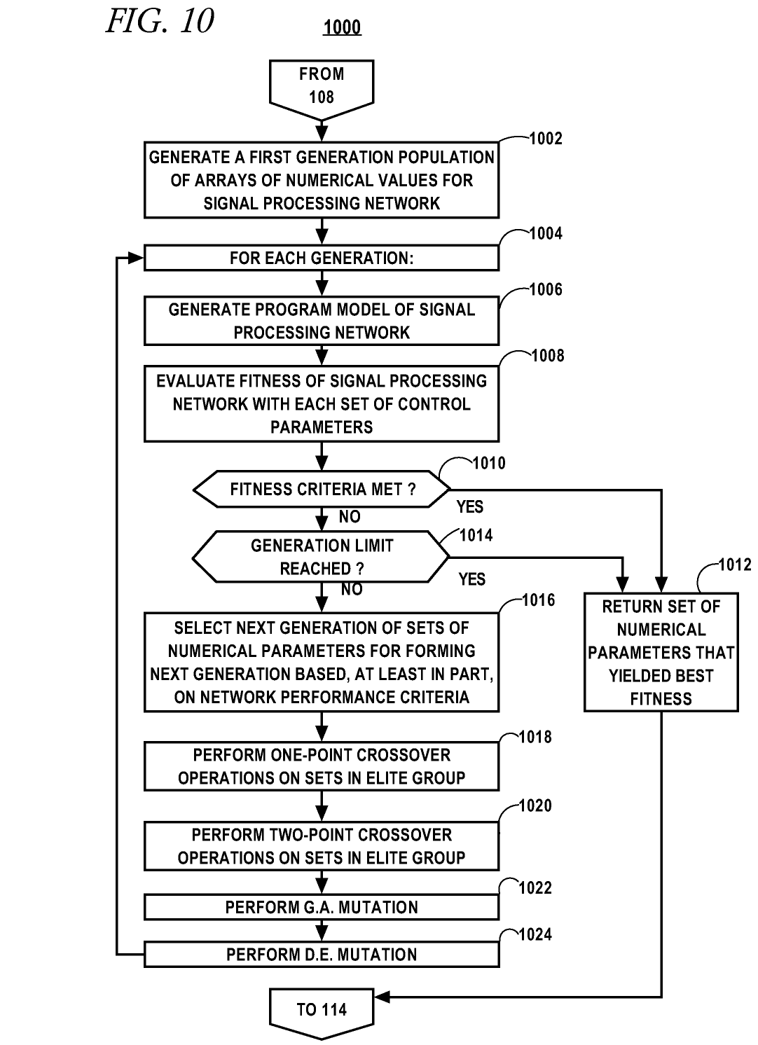

FIG. 10 is a flowchart for a sub-program 1000 for automatically optimizing component values, settings and/or control parameters that is used in the program 100 shown in FIG. 1. The sub-program 1000 shown in FIG. 10 uses a combination Differential Evolution/Genetic Algorithm method. Note that the sub-program 1000 is executed for each population member that is validated in decision block 108. In block 1002, for each valid population member encoding a signal processing network an initial population of arrays of numerical values is generated. Each set of numerical values includes a numerical value for each component value, setting and control parameter used in the signal processing network encoded in the population member. Alternatively, each set of numerical values is a generic set that includes all numerical values for all signal processing elements (i.e., all signal processing elements in Table I) used by the program 100. The arrays of numerical values can be stored as arrays or rows or columns of a matrix. Note that the program 100 and the subprogram 1000 use two distinct types of populations. The program 100 evolves a population of representations of the architecture of signal processing networks with unspecified component values, settings and/or control parameters, whereas the sub-program 1000 evolves a population of values, settings and/or control parameters for each representation of a signal processing network.

Block 1004 is the top of loop that processes successive generations of the populations of arrays of numerical values that are derived from the initial population.

In block 1006 a program model of the signal processing network being processed in the current iteration of the loop started in block 106 is generated. The program model may be developed by nesting calls to sub-programs that model individual signal processing elements. In block 1008 the performance related fitness of the signal processing network, when configured with each set of numerical values is checked. Note that in some implementations blocks 1006 and 1008 may be combined because the sub-programs that model individual signal processing parameters take the component values, settings, and control parameters, in addition to input or intermediate signal samples as sub-program parameters.

FIG. 11 is a flowchart of a sub-program 1100 for evaluating an output of a signal processing network represented in a chromosome array using node-child node associations generated by the sub-program shown in FIG. 5. The sub-program 1100 starts with the root gene of a chromosome array and calls itself recursively in order to work through the signal processing network. Decision blocks 1102, 1112, and 1122 determine if the root gene, codes a two-input (binary) signal processing element, a one-input (unary) signal processing element, an input signal or a constant. (One skilled in the art will appreciate that if the program 100 is to be used to design signal processing networks using signal processing elements that have higher arity, the sub-program 1100 can be expanded to handle such signal processing elements.) If it is determined in block 1102 that the root gene codes an a two-input signal processing element, then in block 1104 the first child gene (which supplies a first input for the two-input signal processing element) is evaluated and in block 1106 a second child gene (which supplies a second input for the two-input signal processing element) is evaluated. In a signal processing network the value of each child is typically a filtered vector of signal values that is derived from a training data input signal vector. The children of the root gene can be located because the location of the children of each gene was found by the sub-program 500 shown in FIG. 5 and described above. Note that the evaluations performed in blocks 1104 and 1106 as well as 1114 described below, are accomplished by recursively calling the sub-program 1100 with the child genes as the root gene (of their sub-tree). In block 1108 current values of the component values, settings and/or control parameters for the two-input signal processing element are read, and in block 1110 the value of the first child, second child and component values, settings and/or control parameters are used to evaluate the output of the two-input signal processing element. The Q-aggregator is one example of a two-input signal processing element.

If it is determined in block 1112 that the root gene encodes a one-input signal processing element, then in block 1114 the child of the root gene is evaluated, in block 1116 the current values of the component values, settings and/or control parameters for the one-input signal processing element are read, and in block 1118 the value of the child and the component values, settings and/or control parameters are used to evaluate the output of the unary signal processing element encoded in the root gene. The Q-filter and the fast Q-filter are two examples of one-input signal processing elements.

Decision block 1120 which is reached if the outcome of decision blocks 1102 and 1112 indicate that the root gene encodes neither a unary nor a binary signal processing element, tests if the root gene encodes an input signal. If so, then the root gene, is set to the value of the input signal. In a signal processing network the input signal is typically a training signal vector. If the outcome of decision block 1120 is negative, then by default the root gene encodes a constant (the only thing left in this particular embodiment) and the value of the root gene is set to the value of the constant.

The sub-program 1100 uses software implementations of the signal processing elements. The sub-program 1100 propagates input signal vectors through a tree representation of a signal processing network from the leaves to the root. However, the sub-program 1100 does this by starting at the root and recursively calling itself to work down toward the leaves. The output of the signal processing network represented by the tree is also a signal vector.

Referring again to FIG. 10, after training data has been processed through the software model of the signal processing network that is encoded in the linear chromosome array being processed, block 1010 test if a fitness criteria has been met. Signal processing network fitness is suitably a quantification of at least two things-the ability of the signal processing network to perform its intended function, and the simplicity or parsimony of the signal processing network. The program for optimizing the component values, settings and control parameters seeks to optimize the signal processing network performance. The goal of network simplicity is addressed in the main program 100.

Supervised training, unsupervised training, or indirectly supervised training can be used to obtain measures of the performance of the signal processing network depending on the nature of the application of the signal processing network.

FIG. 12 is block diagram illustrating a system 1200 of using the program shown in FIG. 1 in a supervised training methodology. In FIG. 12 a genetic programming program 1200, e.g., 100 utilizes a numerical optimization program 1204, e.g., 1000 to design a signal processing network using populations of signal processing network 1206. Unfiltered test signals 1208 are input into program models of each signal processing network, and the output of the program models of the signal processing network that is produced in response to the unfiltered test signals is fed to an objective function computer 1210. Target output signals 1212 are also fed into the objective function computer 1210. The objective function computer 1210 quantifies the discrepancies between the output of the signal processing network produced in response to the unfiltered test signals and the target output signals and produces a result, i.e., a performance related fitness measure that is fed back to the genetic programming program 1202 and the numerical optimization program 1204.

The genetic programming program selects population members for reproduction based, at least in part, on the performance related fitness measure and the numerical optimization program 1204 adjusts component values, settings and control parameters based, at least in part on the performance related fitness measure. In the case that sub-program 1000 shown in FIG. 10 is used as the numerical optimization program 1204, population members representing sets of component values, settings and control parameters are selected for reproduction based, at least in part on the performance related fitness measure.

One example of signal processing system that can be designed by the program 100 shown in FIG. 1 using supervised training fitness evaluation, is a filter for filtering out ambient audio noise, e.g., a system for filtering out road noise from voice audio picked up by a microphone of a cellular telephone being used in a moving automobile. In such a case the unfiltered test signals 1208 can include clean voice audio to which vehicle background noise has been added to degrade the intelligibility and the target output signals can include the clean voice audio.

FIG. 13 is a block diagram illustrating a system 1300 of using the program shown in FIG. 1 in an indirectly supervised training methodology. If indirectly supervised training is used the output of the signal processing networks 1206 is fed to an application specific signal processor 1302. Output of the application specific signal processor 1302 as well as application specific test targets 1304 are fed to the objective function computer 1210.

One example of a situation in which indirectly supervised training could be used is to design a signal processing network for cleaning up a speech audio signal that is to processed by a speech recognition system. In this case, the unfiltered test signals 1208 include speech audio with background noise, the application specific test targets 1304 include information identifying words that are spoken in the speech audio, the speech recognition system is the application specific signal processor 1302, and the objective function computer 1210 computes an objective function that depends on the relative number of correct versus incorrect word recognitions. In this example the system 1300 will serve to design a signal processing system that processes the speech audio in order to maximize speech intelligibility. If the application specific signal processor 1302 requires training such training can be performed prior to training the signal processing network 1206 or simultaneously therewith.

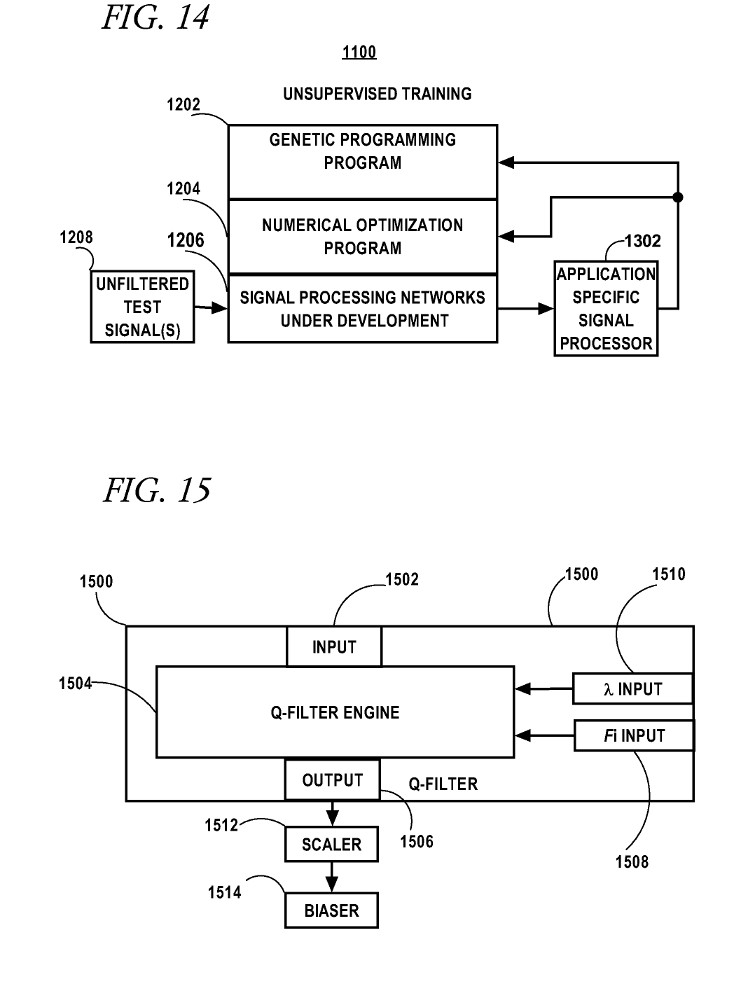

FIG. 14 is a block diagram illustrating a system 1400 utilizing the program 100 shown in FIG. 1 in an unsupervised training methodology. In an unsupervised set up no target output signals 1212 are provided so no objective function computer 1210 is required to compare the target output signals 1212 or application specific test targets 1004 to the output of the signal processing networks 1206, however the application specific signal processor 1002 is used to process the output of the signal processing networks 1206. In unsupervised training, the genetic programming program 1202 and the numerical optimization program 1204 seek to design a signal processing network that maximizes or minimizes the output of the application specific signal processor 1002. In this case the performance related fitness measure is the output of the applications specific processor 1002 or a function thereof.

An example of an application in which unsupervised training could be used is to design a filter network for pre-filtering the input to a correlating wireless signal detector, e.g., in a Code Division Multi-Access (CDMA) receiver. In this case the input signals 1208 include a clean signal to which noise has been added and/or which has been subjected to linear and/or non-linear distortion and the application specific signal processor 1002 is a software model of a correlating wireless signal receiver. In this example, the system 1400 is used to find one or more signal processing networks that compensate for noise and distortion in order to maximize the output (the integrated product) of the correlating wireless signal receiver. Conventionally, pulse shape match filters and equalizing filters that are based on simplifying assumptions of white noise and linear distortion are used for pre-filtering the input to correlating wireless detectors. However, such filters may have limitations in certain real world radio environments. Supervised training can also be used to design a filter network for pre-filtering the input to a correlating wireless signal detector, if a time-varying, information bearing signal is used for the input signals 1208.

Referring again to FIG. 10 if it is determined in block 1010 that the performance related fitness criteria has been met then in block 1012 the set of component values, settings and control parameters that yielded the highest fitness for the signal processing network is returned to the main program 100 which continues executing at block 114.

On the other hand if it is determined in block 1010 that the fitness criteria has not yet been met, then execution proceeds to decision block 1014 the outcome of which depends on whether a generation limit has been reached. Note that the generation limit tested in block 1014 applies to the population of component values, settings and control parameters. If the generation limit has been reached the sub-program branches to block 1012, described above. If on the other hand the generation limit has not been reached, then in block 1016 the next generation of sets of numerical parameters (component values, settings and control parameters) is selected from the current generation based, at least in part, on fitness. According to the certain embodiments, population members are selected for replication using a stochastic remainder method. In the stochastic remainder method at least a certain number Iⱼ of copies of each population member are selected for replication in a successive generation. The number Iⱼ is given by the following equation:

$${I}_{i} = Trunc ( N * \frac{{PF}_{i}}{{\sum }_{i = 1}^{N} {PF}_{i}} ) \qquad EQU . 1$$

where, N is the number of population members in each generation;
PFᵢ is the fitness of the i^{th} population member determined in block 1008; and
Trunc is the truncation function.

The fractional part of the quantity within the truncation function in equation one is used to determine if any additional copies of each population member (beyond the number of copies determined by equation one) will be replicated in a successive generation. The aforementioned fractional part is used as follows. A random number between zero and one is generated. If the aforementioned fractional part exceeds the random number then an addition copy the i^{th} population member is added to the successive generation. The number of selections made using random numbers and the fractional parts of numbers Iⱼ is adjusted so that successive populations maintain a programmed total number N of sets of numerical parameters.

Using the above described stochastic remainder method leads to selection of population members for replication based largely on fitness, yet with a degree of randomness. The latter selection method mimics natural selection in biological systems.

In block 1018 one point cross-over operations are performed on some of the arrays of numerical values that have been selected for replication. In block 1018 two-point crossover operations are performed on some of the arrays of numerical values that have been selected for replication. In performing crossover operations population members are paired together (e.g., randomly). A single crossover probability or separate crossover probabilities may be used in deciding whether or not to perform one and two point crossover operations. For each type of crossover operation, and for each pair of population members a random number between zero and one is generated. If the random number is less than the crossover probability, then a crossover operation is performed, if the random number is greater than the crossover operation then the pair of population members is kept unchanged. Alternative methods for determining whether crossover operations are performed may be used. If it is determined that a one point crossover operation is to be performed between a pair of population members then a crossover point is selected at random. Thereafter, all the elements (numerical values) in the two population members that follow the crossover point are exchanged between the two arrays of numerical values. If it is determined that a two-point crossover operation is to be performed between two population members, then two points are selected at random and elements of the population members (arrays of numerical values) between the two points are exchanged.

In block 1022 a genetic algorithm (G.A.) mutation operation is performed on selected numerical values. One form of G.A. mutation is expressed by the following formula:

xᵢ^{new}=xᵢ+(rand−0.5)(0.1xᵢ+eps) EQU. 2

where,
xᵢ is a numerical value being mutated
xᵢ^{new} is a mutated numerical value;
eps is a machine constant equal to the smallest number that can be represented in the floating point system of the machine

Note that equation two illustrates a mutation limited to maximum of plus or minus 5%. 5% is a reasonable limit for mutation but may be changed if desired.

In block 1024 differential evolution (D.E.) mutation is performed on selected population members. Note that in D.E. mutation operates on an entire population member which is an set of numerical values. Note also that in performing D.E. mutation the population member is treated as an ordered set (e.g., vector or array) of numerical values. One form of D.E. mutation is expressed by the following formula:

Xᵢ^{new}=X_{best}+f·(Xⱼ+Xₖ−Xₗ−Xₘ) EQU. 3

where,
Xᵢ^{new} is a new population member that replaces population member Xᵢ that has been selected for D.E. mutation;
X_{best} is the population member that yielded the highest fitness;
Xⱼ, Xₖ, Xₗ, Xₘ, are other population members (e.g., other population members selected at random; and
f is a scalar factor that is suitably set to a value in the range of between zero to two.

Every numerical value in the replicated population is considered a candidate for applying G.A. mutation and every array of numerical values is considered a candidate for D.E. mutation. In order to determine whether G.A. mutation and D.E. mutation is applied to each numerical value and set of numerical values respectively, a random number between zero and one can be generated for each entity and compared to preprogrammed G.A. and D.E. mutation probabilities. If the random number is less than the preprogrammed G.A. or D.E. mutation probabilities then the entity (i.e. numerical value or array of numerical values respectively) is mutated. Although not shown in FIG. 10, alternatively other evolutionary operations may be performed.

After, block 1024, the sub-program loops back to block 1004 and continues executing as previously described. Thus, successive generations of populations of arrays of numerical values will be evolved until the performance related fitness criteria is met or a generation limit is reached.

After the sub-program 1000 is exited, upon returning to the main program 100 shown in FIG. 1, block 114 is executed. In block 114 a parsimony fitness measure that is indicative of the simplicity of the signal processing network is computed. Simplicity is preferred because it generally implies less complex hardware and low power consumption. One way to quantify cost is to sum a cost assigned to each signal processing element of a signal processing network. The cost associated with each signal processing element is given in the fourth column of table 1. Thus, according to certain embodiments, the parsimony related fitness for a j^{th} signal processing network is:

$${NC}_{j} = {\sum }_{network} {Cost}_{i} \qquad EQU . 4$$

where, NCⱼ stands for the cost of the j^{th} signal processing network; and

Costᵢ is the cost of the i^{th} signal processing element in the j^{th} signal processing network.

Next, the program 100 continues to decision block 116 which tests if more population members in the current generation remain to be processed. If so block 118 gets a next population member and then the program 100 loops back to block 108 and continues executing as previously described until all population members of the current generation have been processed.

When it is determined in decision block 116 that all of the population members of the current generation have been processed, then the program branches to block 120. Decision block 120 tests if an overall fitness goal has been reached. The overall fitness goal takes into account the fitness measure related to signal processing performance and the parsimony related fitness. According to one embodiment, the two component fitness measures are combined in a weighted sum that uses a programmed weight, i.e.:

Fⱼ=(1−p)·PFⱼ+p·NCⱼ EQU. 5

where, Fⱼ is an overall measure of fitness of an j^{th} signal processing network that is represented by an j^{th} population member;

PFⱼ is the performance related fitness measure;

NCⱼ is the parsimony related fitness measure; and

p is a parsimony weighting factor that determines the weight to be given to the parsimony related measure of fitness in the overall measure of fitness.

The decision block 116 compares the overall fitness to a programmed fitness goal G. According to certain embodiments the parsimony weighting factor p and the goal G are varied during the run of the program 100. For example the parsimony weighting factor p can initially be set to a low value (and possibly to zero), and later increased. The timing of changing the p and G can be based on the value of the overall fitness measure, the generation-to-generation change of the overall fitness measure or on the generation number.

If it is determined in block 116 that the fitness goal G has been satisfied, then the program 100 branches to block 126 in which information on the signal processing network that satisfied the fitness goal is output e.g., on a computer display. The information can also be written to an output file.

If it is determined in block 116 that the fitness goal has not yet been satisfied then in block 122 population members are selected for replication in the next generation based on overall fitness. The same stochastic remainder method discussed above that is used in selecting from populations of arrays of numerical values in the sub-program 800 can be used in block 122 as well. However, in block 122 it is the overall fitness that is used in the stochastic remainder method. The overall fitness includes the performance related fitness that is achieved with the highest fitness set of numerical values for each particular network.

Next in block 124 evolutionary operations are performed on the populations members (e.g., arrays, vectors, rows or columns) that have been selected in block 122. The evolutionary operations that are performed suitably include one-point crossover, two-point crossover and mutation. The one-point and two-point crossover operations are the same as described above in connection with sub-program 800 but are applied to the population members representing signal processing networks that are evolved by the main program 100. In program 100 mutation involves replacing a randomly selected gene (e.g., signal processing element or signal source) with another randomly selected gene. Determination of whether a particular gene in a particular chromosome will be mutated can be made using random numbers between zero and one and a programmed mutation rate as described above in connection with G.A. mutation and D.E. mutation performed in sub-program 800.

Block 122 and block 124 serve to prepare a new generation of signal processing networks by selecting members of the current generation for inclusion in the next generation based on fitness, and then performing evolutionary operation on the selected members. After block 126 the program 100 loops back to block 106 in order to process the new generation, as previously described.

Because of the lack of constraints on the design space that is explored by the program 100 signal processing networks for a variety of applications can be designed. Signal processing networks that do not conform to standard engineering practice and whose operation is not intuitively understood may be designed. A further enhancement to versatility and efficiency of the program 100 comes from using versatile configurable signal processing elements in the signal processing network. Three such versatile configurable signal processing elements are the Q-filter, the fast Q-filter and the Q-aggregator discussed above, and in more detail below.

FIG. 15 is a block diagram of a highly versatile Q-filter 1500 that can be used in signal processing systems designed by the program shown in FIG. 1 along with a signal scaler 1512 and a biaser 1514. The Q-filter 1500 comprises a signal input 1502 coupled to a Q-filter engine 1504 and a Q-filter output 1506 coupled to the Q-filter engine 1504. An first control input 1508 for receiving a set of coefficients f^{j} (also known as ‘densities’) and a second control input 1510 for receiving a nonlinearity determining parameter λ are also coupled to the Q-filter engine 1504. The set of coefficients f^{j} and the nonlinearity determining parameter λ are control parameters which are set in block 112 (e.g., by sub-program 800). The Q-filter is described in co-pending patent application Ser. No. 10/854,836 mentioned above. It is noted that the Q-filter can be implemented as a programmed processor (e.g., a programmable Digital Signal Processor) or using specialized hardware.

A Q-filter can be defined by the following sequence of equations:

e=rₘᵢₙ+C EQU. 6

where,

e is a filtered signal sample,

rₘᵢₙ is a minimum of an ordered sequence of thresholds to which the input signal Sⱼ is compared. The ordered sequence of thresholds is represented as: rₒ<r₁< . . . <rₘ₋₁. Note that rₘᵢₙ=rₒ<=Sⱼ<=rₘ₋₁=rₘₐₓ. The input signal is bounded between minimum threshold rₘᵢₙ and maximum threshold rₘₐₓ. If necessary, preamplification or attenuation is used to scale the signal appropriately. Furthermore:

$$C = {\sum }_{i = 1}^{m - 1} {q}_{i} \frac{{r}_{max} - {r}_{min}}{m - 1} = \frac{{r}_{max} - {r}_{min}}{m - 1} {\sum }_{i = 1}^{m - 1} {q}_{i} \qquad EQU . 7$$

where

$${q}_{i} = \{ \begin{matrix} \frac{{\prod }_{j = 1}^{n} ( 1 + λ {h}_{ij} {f}^{j} ) - 1}{F} , & λ \geq - 1 , λ \neq 0 \\ \frac{{\sum }_{j = 1}^{n} {h}_{ij} {f}^{j}}{F} , & λ = 0\end{matrix} \qquad EQU . 8$$

where,

λ>=−1 is a filter control parameter; and

$$F = \{ \begin{matrix}{\prod }_{j = 1}^{n} ( 1 + λ {f}^{j} ) - 1 , & λ \geq - 1 , λ \neq 0 \\ {\sum }_{j = 1}^{n} {f}^{j} , & λ = 0\end{matrix} \qquad EQU . 9$$

where,
f^{j} are a sequence of density parameters in the range [0,1], and
hᵢⱼ=1 for Sⱼ>=rᵢ and otherwise hᵢⱼ=0.

Generally the thresholds rᵢ will be evenly spaced, although unevenly spaced threshold may be used as well. Once the spacing of the thresholds has been fixed, the values of the parameter λ and of the density parameters f^{j} remain to be fixed in order to fully define a Q-filter.

The scaler 1512 and biaser 1514 linearly transform the output of the Q-filter 1500. Thus the output of the biaser 1514 can be described by

e_{LT}=α·e+β EQU. 10

where,
e_{LT} is the linearly transformed output of the biaser 1514;
α is a scaling factor; and
β is a bias.

The scaler 1512 and the biaser 1514 can be included as separate signal processing elements that the program 100 uses to construct a signal processing system or can be incorporated into the Q-filter signal processing elements.

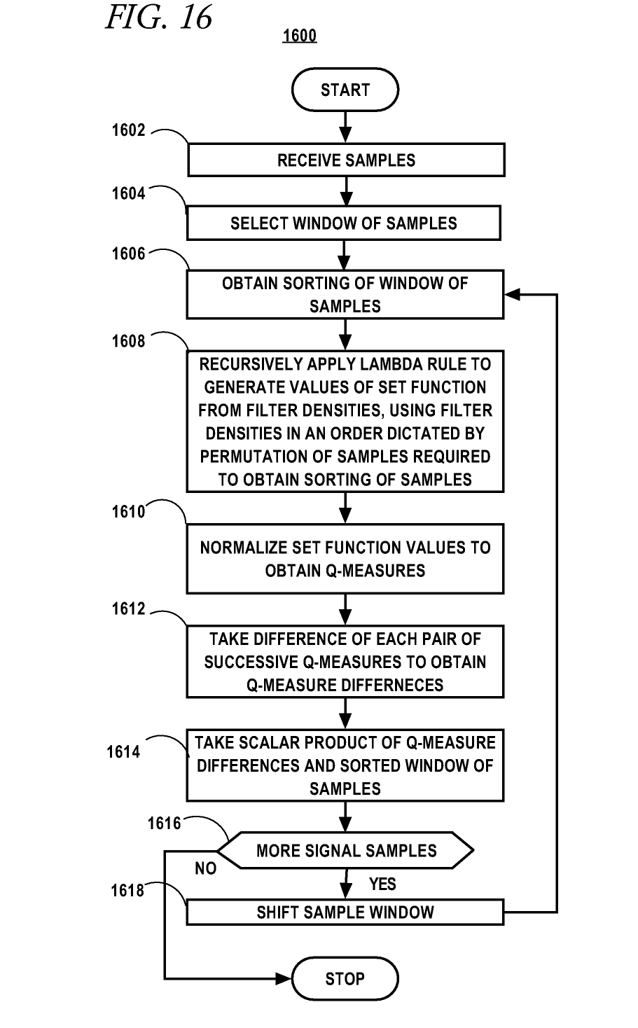

An alternative to the Q-filter is the fast Q-filter covered in co-pending patent application entitled “Fast Q-Filter”, Ser. No. ______ (Docket No. CML02826T). FIG. 16 is a flowchart 1600 of the operation of the fast Q-filter. In block 1602 a series of signal samples are received. The samples might typically be received from a digital-to-analog converter coupled to a detector, sensor or transducer. In block 1604 a window of programmed length is selected from the series of samples for filtering.

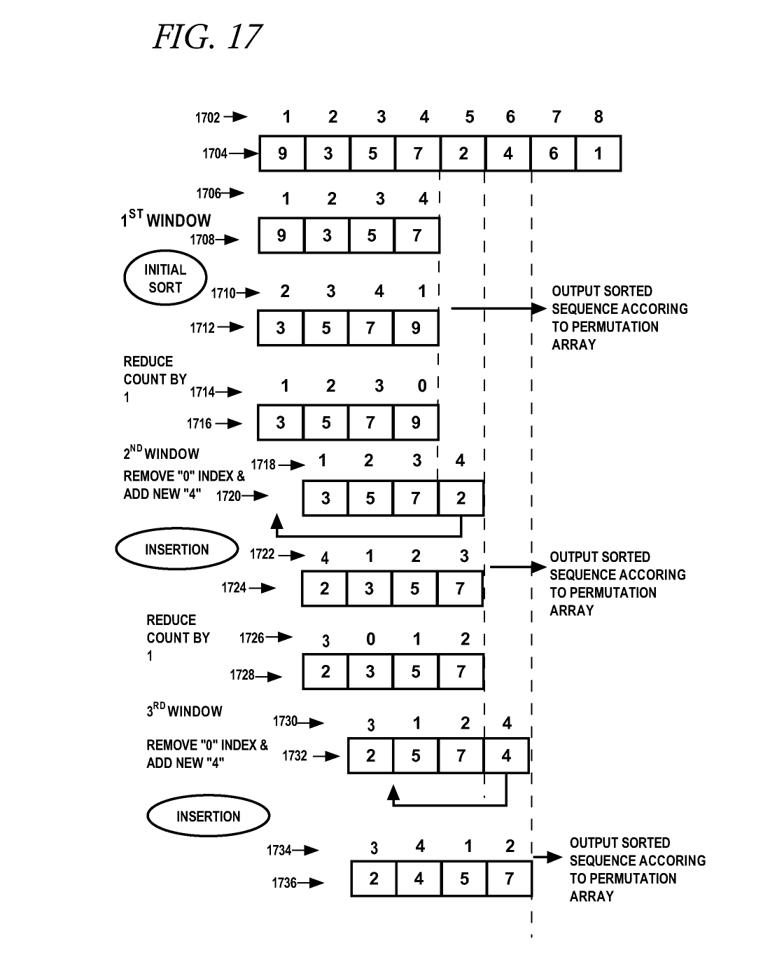

In block 1606 a sorting of the window of samples is obtained. The sorting can take the form of an actual sorted array of samples, but can also take the form of a permutation array in which indexes referring to time indexes in the window of samples are sorted according to the magnitude of the samples referred to. The sorting can be base on magnitude or absolute magnitude. FIG. 17 graphically illustrates a sliding window indirect insertion sort that is used in the fast Q-filter. The first row is a series of time indexes 1702 for signal samples, the second row is a hypothetical series of samples 1704. The third row is a permutation array 1706 shows sample position numbers one to four for a first window of samples 1708 that is four samples long. The fifth row is a permutation array 1710 that describes an initial sorting of the first window 1708. The sixth row 1712 shows the samples in the first window 1708 in sorted order. Note that by using indirect referencing through the permutation array 1710 actual sorting of the signal samples in each window may be avoided, however signal samples are shown in row 1712 to elucidate the meaning of the permutation array 1710.

Referring again to FIG. 16 in block 1608 a so-called lambda rule which nonlinearly combines two quantities, is recursively applied to a set of filter densities to generate values of a set function over the densities. In doing so the densities are used not in their original order (e.g., as stored in an array), but in an order determined by the permutation array for the signal samples. The recursion is given by the following equation:

ψᵢ=f₍ᵢ₎+ψᵢ₊₁+λf₍ᵢ₎ψᵢ₊₁,i=n, . . . , 1 EQU. 11

where,

ψₙ₊₁=0 and

f₍ᵢ₎ε[0,1] is an i^{th} filter parameter in a permutation of the filter parameters according to the same permutation required to sort the signal samples. The filter densities fᵢ and λ are control parameters that are optimized in block 112 (e.g., in sub-program 800).

Note that the recursion relation given by equation 11 may change for each window of samples because the order in which the densities f₍ᵢ₎ are used. It will be apparent to one skilled in the art that a programmed processor can be used to evaluate the recursion relation. However, a specialized hardware solution has also been developed. Co-pending patent application entitled “Hardware Arithmetic Engine for Lambda Rule Computations”, Ser. No. ______ (Docket No. CML03293T) to Irfan Nasir et al. discloses hardware for evaluating the recursion relation given by equation 11.

In block 1610 the set function values are normalized by dividing each one by the largest which is ψ₁ to obtain a set of so-called “Q-measures”. Q-measures are describe in “Q-measures: An Efficient Extension of the Sugeno λ-Measure”, IEEE Transactions on Fuzzy Systems, Vol. 11, No. 3, June 2003.

In block 1612 successive pairs of Q-measures are subtracted to obtain a set of Q-measures discrete differences, given by the following equation:

$$Δ {q}_{i} = \frac{{ψ}_{i} - {ψ}_{i + 1}}{{ψ}_{1}} \qquad EQU . 12$$

In block 1614 the scalar product of the signal samples in the window (taken in order according to magnitude) and the Q-measures discrete differences is computed. The result obtained from block 1614 is a fast Q-filtered signal sample. As discussed above in reference to FIG. 12, the fast Q-filtered signal sample can also be scaled and biased.

Block 1616 test if there are more received signal samples beyond the window that has just been processed in blocks 1606-1614. If so, then in block 1618 the sample window is shifted by one sample position, the fast Q-filter returns to block 1606 in order to repeat the cycle described above. When there are no more samples to process the fast Q-filter stops.

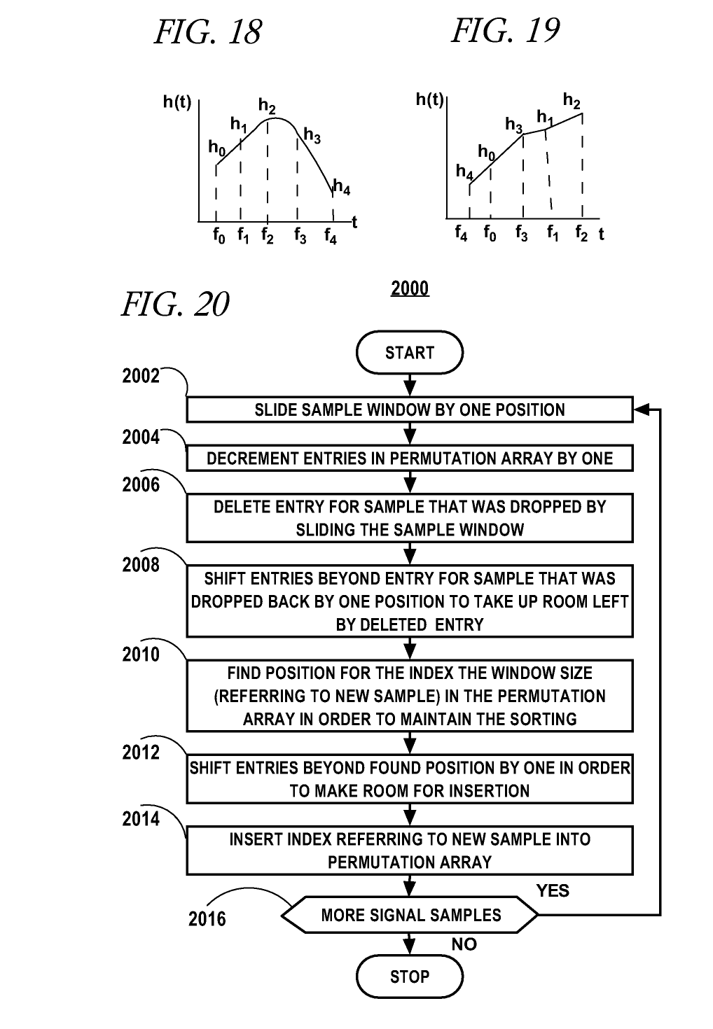

FIGS. 18-19 illustrate how signal samples and filter parameters are reordered by the Q-filter. FIG. 18 is a plot of a signal covering a period of five signal samples labeled h₀ to h₄. Under the time-axis of the plot a sequence of filter density parameters f₀ to f₄ are shown. FIG. 19 shows a plot with the signal transformed so that the signal samples h₀ to h₄ appear in order of increasing magnitude. The filter density parameters h₀ to h₄ are shown in FIG. 19 reordered according to the same permutations required to order the signal samples f₀ to f₄ in increasing order.

FIG. 20 is a flowchart of a sliding window indirect insertion sort 2000 that is used by the fast Q-filter. The sliding window indirect insertion sort is useful in maintaining the permutation array in an efficient manner i.e., without requiring resorting each new window. The sliding window indirect sort is characterized by a linear time as opposed to O(n log(n)) which characterizes sorting each window independently by known efficient prior art methods, e.g., the quick sort. At the start of the sort 2000 it is assumed that an indirect sort of the first window has already been performed yielding an initial permutation array. A variety of methods, e.g., a standard insertion sort, can be used to sort the initial window of samples. In block 2002 the sample window is slid by one position in order to drop one signal sample and pick up a new signal sample. In block 2004 entries in the permutation array are decremented by one. In block 2006 the entry for the sample that was dropped by sliding the window (i.e., an entry equal to one) is deleted. In block 2008 the entries beyond the sample that was dropped are shifted back by one position to take up room left by deleted entry. In block 2010 the position in the permutation array for the entry referring to the sample added by shifting the window is located. In block 2012 indexes beyond the position found in block 2010 are shifted by one position in order to make room for insertion and in block 2014 an entry (i.e., an index equal to the window size) referring to the sample added to the window by sliding the window is inserted in the position located in block 2010. Block 2016 test if more signal samples are being input and if so loops back to block 2002 to repeat the process described above. Note that before updating the permutation array other fast Q-filter operations are performed as described above with reference to FIG. 13.

Referring again to FIG. 17 the sliding window indirect insertion sort is illustrated graphically. A seventh row 1714 shows the result of decrementing each entry in the first permutation array by one, while the eighth row 1716 shows the first window of signal samples again. The tenth row 1720 shows a second window of signal samples that is obtained by sliding the first window of signal samples 1716 by one sample position. The ninth row 1718 shows the first permutation array 1710 after dropping the zero entry which referred to the signal sample that was dropped by sliding the window, and adding a new entry with index four referring to a signal sample that was added by sliding the window. The eleventh row 1722 shows the result of reordering the permutation array so that the permutation array describes a monotonic ordering of the signal samples. The twelfth row 1724 shows the signal samples in the second sample window ordered according to the permutation array in the eleventh row 1722. Rows 1726-1736 illustrate a repletion of the process illustrated in rows 1714-1724 for a third window of signal samples. It is noted that the sliding window indirect insertion sort is applicable for accelerating any type of digital signal processing filter that treats samples based on position in a magnitude sorting within each window, as opposed to treating samples based on original position within each window (as in classical FIR, IIR filters).

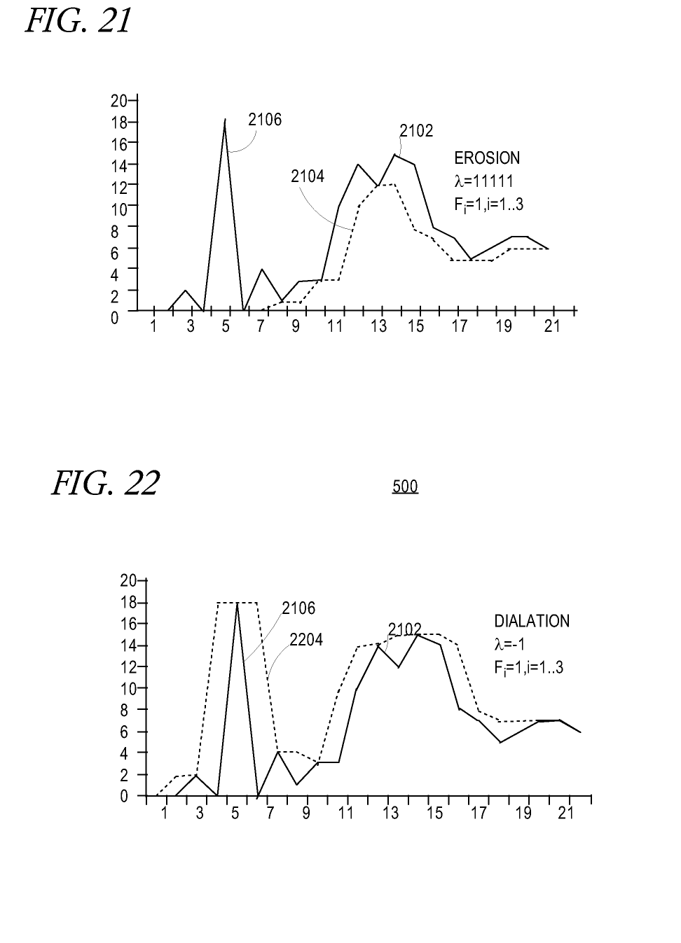

FIG. 21 is a first signal plot 2100 showing an unfiltered signal 2102 and along with a filtered signal 2104 obtained by filtering the unfiltered signal 2102 with a fast Q-filter (e.g., 1600) configured to emulate an erosion filter. The window size was three. To obtain the filtered signals shown in FIGS. 21-23 the filter density parameters f₁, f₂, f₃ where set equal to one. In the case of the FIG. 21 λ was set equal to 1111. Note that the unfiltered signal 2102 includes a noise spike 2106 that is eliminated from the filtered signal 2104. The fast Q-filter configured as an erosion filter also generally reduces the signal energy.

FIG. 22 is a second signal plot 2200 showing the unfiltered signal 2102 and along with a filtered signal 2204 obtained by filtering the unfiltered signal 2102 with a fast Q-filter configured to emulate a dilation filter. In order to configure the fast Q-filter to emulate a dilation filter A was set equal to minus one. The fast Q-filter configured as a dilation filter increases the signal energy and the energy in the noise spike 2106.

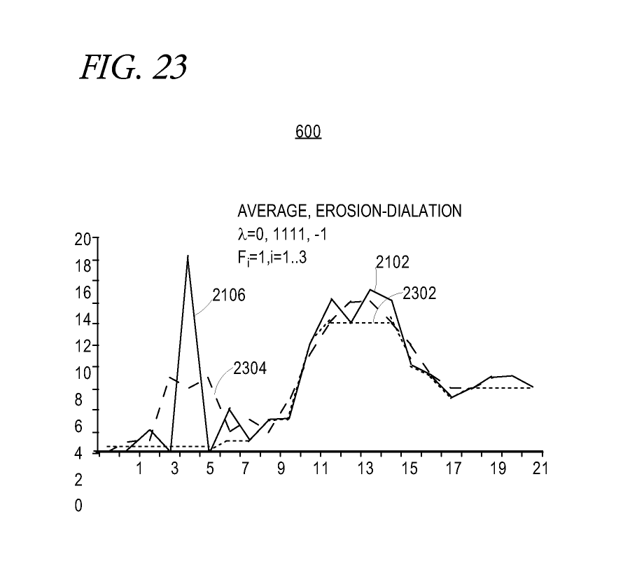

FIG. 23 is a third signal plot 2300 showing the unfiltered signal 2102 along with one filtered signal 2302 obtained by filtering the unfiltered signal with two fast Q-filter configured to emulate an opening filter and one filtered signal 2304 obtained by filtering with a fast Q-filter configured to function as an averaging filter. An opening filter is emulated by a first fast Q-filter stage configured to emulate an erosion filter (e.g., with λ=1111), followed by a second fast Q-filter stage configured to emulate a dilation filter (e.g., with λ=−1). Two fast Q-filter configured to emulate an opening filter serve to remove the noise spike and substantially restore the signal energy of the unfiltered signal 2102. A fast Q-filter is adapted to act as an averaging filter by setting λ equal to zero. Although the fast Q-filter adapted as an averaging filter reduce the amplitude of the noise spike it is not completely eliminated. Thus at the expense of the added complexity of providing two fast Q-filters in series a filter system that may be better able to handle noise is provided. By also allowing λ and the filter density parameters [f₁,f₂,f₃ . . . fⱼ . . . f_{ndensities}] to vary the fast Q-filters can be configured to cover a new space of filter designs that includes the averaging filter as a special case, can emulate morphological filters such as the erosion filter, the dilation filter, the opening filter and the closing filter but also includes new types of filters that are intermediate the know types of filters. Thus, the character of a fast Q-filter varies substantially as λ and the filter density parameters [f₁,f₂,f₃ . . . fⱼ . . . f_{ndensities}] are varied. The numerical optimization performed in block 112, e.g., using sub-program 1000 will optimize λ and the filter density parameters [f₁,f₂,f₃ . . . fⱼ . . . f_{ndensities}] for each signal processing network application using fast Q-filters.

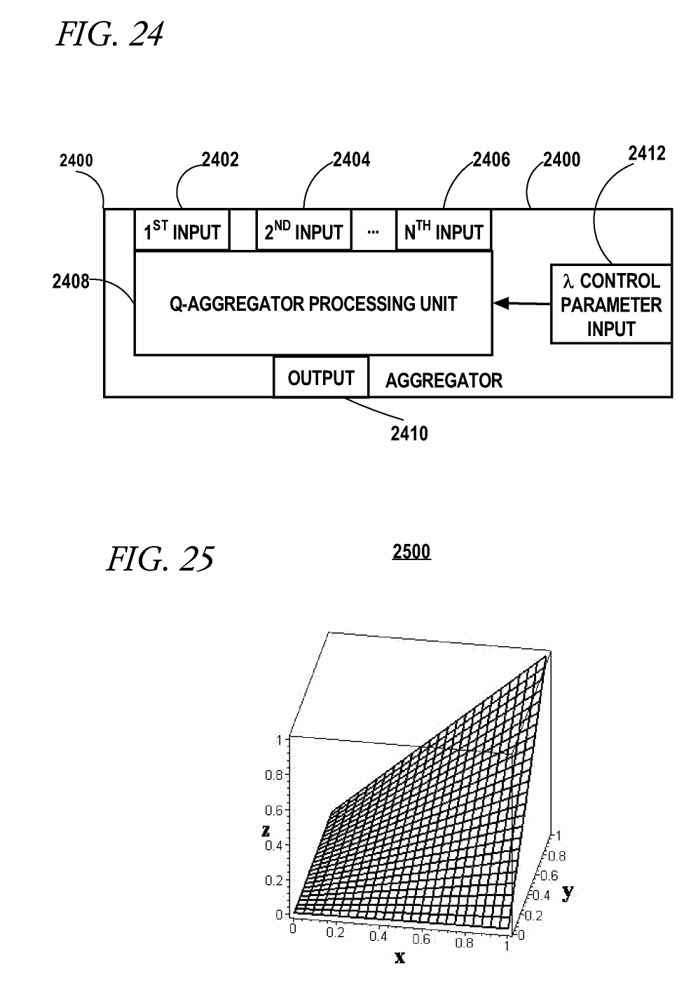

FIG. 24 is a block diagram of a configurable, adaptive signal Q-aggregator 2400 that can be used in signal processing systems designed by the program shown in FIG. 1. The Q-aggregator 2400 comprises a first aggregator input 2402, a second aggregator input 2404 and an N^{TH} aggregator input 2406 coupled to an Q-aggregator processing unit 2408. The aggregator processing unit 2408 is coupled to an aggregator output 2410. A control parameter input 2412 is used to input a control parameter. The control parameter input 2412 is also coupled to the Q-aggregator processing unit 2408. The value of the control parameter is to be established in block 112, e.g., sub-program 800. Although three inputs 2402, 2404, 2406 are shown in FIG. 24 for the purpose of illustration, alternatively two-inputs or more than three inputs are provided. The Q-aggregator processing unit 2408 is adapted to execute an aggregator function that is modeled by the following equation:

$${h}_{λ} ( {a}_{1} , … , {a}_{n} ) = \{ \begin{matrix} \frac{{\prod }_{i = 1}^{n} ( 1 + λ {a}_{i} ) - 1}{{\prod }_{i = 1}^{n} ( 1 + λ ) - 1} & λ \geq - 1 , λ \neq 0 \\ \frac{1}{n} {\sum }_{i = 1}^{n} {a}_{i} & λ = 0\end{matrix} \qquad EQU . 13$$

where,
λ>=−1 is the control parameter that is used to configure the aggregator 2400;
aₖε[0,1] is a kth input to the aggregator 2400;
n>1 is a number of inputs; and
h_{λ}(a₁, . . . ,aₙ)ε[0,1] is the output of the aggregator 2400.

The number of inputs n is varied as needed for a particular system. The aggregator processing unit 2408 suitably comprises, by way of example, a microprocessor coupled to a memory that stores programming instructions for executing the aggregator function, or an Application Specific Integrated Circuit (ASIC), or a Field Programmable Gate Array (FPGA) configured to perform the aggregator function. In a hardware implementation the first input 2402, second input 2404, third input 2406 and control signal input 2412 can take the form of dedicated signal inputs. The hardware disclosed in the aforementioned co-pending patent application “Hardware Arithmetic Engine for Lambda Rule Computations”, Ser. No. ______ (Docket No. CML03293T) to Irfan Nasir et al. can also be used in implementing the Q-aggregator processing unit 2408. Depending on the setting of the control parameter λ the Q-aggregator processing unit 2408 can be configured to emulate a number of known functions, that are useful in signal processing systems.

Setting the control parameter to λ to a high value e.g., one-hundred causes the aggregator processing unit 2408 to perform a function that approximates the MIN function. The MIN function accepts two arguments and returns the lesser of the two as its output. With the control parameter λ set at a high number the aggregator 2400 also emulates the generalized mean with the exponent equal to a large negative number. Note that the generalized mean with the exponent equal to a large negative number is suitably used as a smooth approximation of the MIN function. The MIN function is often used in multi-valued logic systems to combine the membership functions of inputs that are connected by an intersection operator.

Considering the case in which the aggregator 2400 has only two-inputs, allows the input/output relation of the aggregator 2400 to be visualized using surface plots. FIG. 25 is a surface plot 2500 showing the input-output relation of the Q-aggregator shown in FIG. 24 when the aggregation function is configured by setting the control parameter λ equal to one-hundred in order to emulate a MIN function, which is suitably used as the fuzzy intersection operator. In FIGS. 25-27, the X-axis indicates a first input magnitude, the Y-axis indicates a second input magnitude and the Z-axis indicates the aggregator output magnitude.

Setting the control parameter λ to values approaching or equal to negative one causes the aggregator processing unit 2408 to perform a function that approximates the MAX function. The MAX function accepts two arguments and returns the greater of the two as its output. With the control parameter λ set at a number approaching or equal to negative one the aggregator 2400 also emulates the generalized mean with the exponent equal to a large positive number. The generalized mean with the exponent equal to a large positive number is suitably used as a differentiable approximation of the MAX function. The MAX function is often used in multi-valued logic systems to combine the membership functions of inputs that are connected by a union operator.

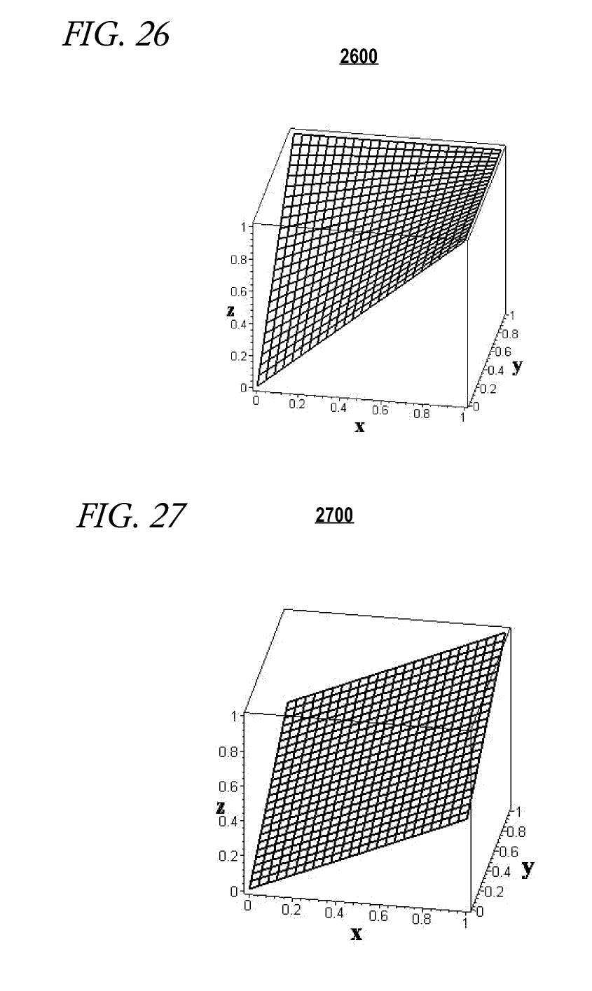

FIG. 26 is a surface plot 2600 showing the input-output relation of the aggregator 2400 when the control parameter is set equal to negative one in order to emulate the MAX function.

Setting the control parameter λ to values approaching zero (e.g., 0.0001) causes the aggregator 2400 to output a value that approximates the average of the two-input values. Averaging is a fundamental process that is applicable to a variety of types of technical systems including signal processing systems.

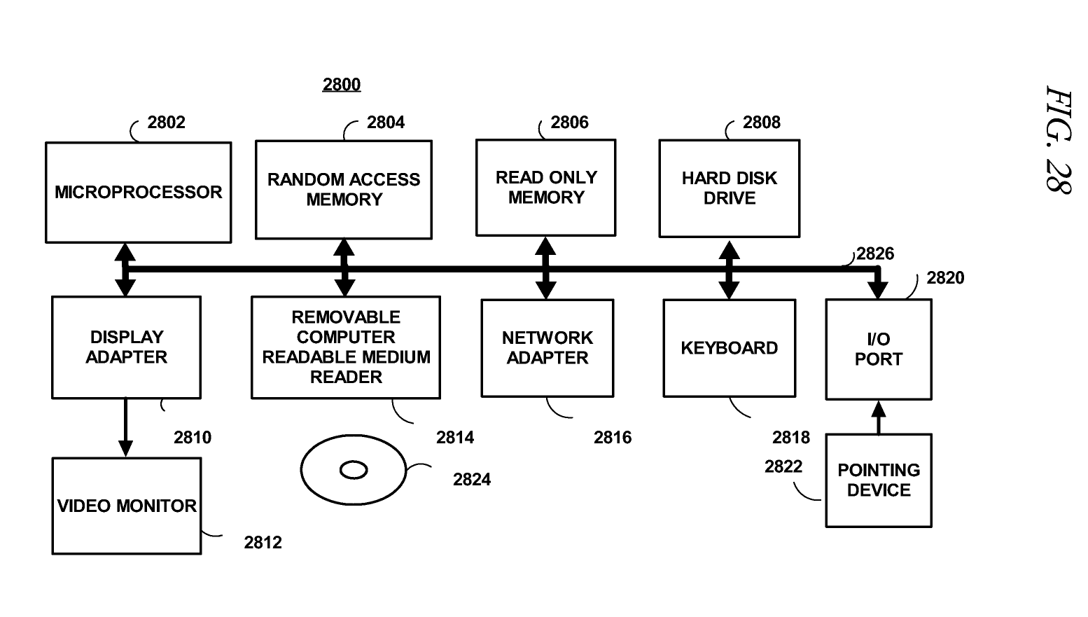

FIG. 27 is a surface plot 2700 of the input-output relation of the aggregator 2400, when the aggregator 2400 is configured by the control parameter setting to approximate the averaging function. The surface plot 2700 is based on a control parameter setting of 0.0001.

The settings of the parameter λ discussed above are merely exemplary. In practice, the parameter λ can take on different values, e.g., values in the range the range −1 to plus infinity.

The ability to change the character of the aggregating function qualitatively by adjusting the value of the parameter λ, facilitates discovery of an appropriate signal processing function (e.g., MIN, MAX, average, or some intermediate function) in the course of machine learning in program 100.

FIG. 28 is a block diagram of a computer 2800 that can be used to execute the programs described above according to embodiments of the invention. The computer 2800 comprises a microprocessor 2802, Random Access Memory (RAM) 2804, Read Only Memory (ROM) 2806, hard disk drive 2808, display adapter 2810, e.g., a video card, a removable computer readable medium reader 2814, a network adaptor 2816, keyboard 2818, and I/O port 2820 communicatively coupled through a digital signal bus 2826. A video monitor 2812 is electrically coupled to the display adapter 2810 for receiving a video signal. A pointing device 2822, suitably a mouse, is coupled to the I/O port 2820 for receiving signals generated by user operation of the pointing device 2822. The network adapter 2816 can be used, to communicatively couple the computer to an external source of data, e.g., a remote server. The computer readable medium reader 2814 suitably comprises a Compact Disk (CD) drive. A computer readable medium 2824, that includes software embodying the programs described above is provided. The software included on the computer readable medium 2824 is loaded through the removable computer readable medium reader 2814 in order to configure the computer 2800 to carry out programs of the current invention that are described above with reference to the FIGs. The computer 2800 may for example comprise a personal computer or a work station computer. A variety of types of computer readably medium including, by way of example, optical, magnetic, or semiconductor memory are alternatively used to store the programs, sub-programs and data-structures described above. It will be apparent to one of ordinary skill in the programming art that the programs may be varied from what is described above.

The relationship of the main program 100 to the sub-programs 500, 600, 1000, 1100, 1600, 2000 is as follows. The main program basically handles network topology aspects of the design of the signal processing networks using a form of gene expression programming. The main program calls sub-program 600 to validate chromosome arrays encoding network topology. The main program 100 calls the sub-program 1000 for optimizing numerical parameters using a combination of genetic algorithm/differential evolution algorithm. The sub-program 1000 calls sub-program 500 to decode chromosome arrays in order extract encoded network topology information. The sub-program 1000 calls sub-program 1100 to simulate signal processing by signal processing networks encoded in chromosome arrays, where the signal processing networks are configured with trial numerical parameters selected by the sub-program 1000. The sub-program 1100 relies on network topology information generated by the sub-program 500. Sub-programs 500 and 1100 are used in block 1006 and 1008 of sub-program 1000. If a signal processing network generated by the main program 100 includes a fast Q-filter, sub-program 1600 is used for the fast Q-filter. Sub-program 2000 is used in block 1606 of sub-program 2000.

By using a separate specialized numerical optimizations for finding optimum component values, settings and configuration parameters, a genetic programming program (e.g., 100) can be relieved of the burden of finding numerical values so that the genetic programming program will be focused on the task to which it is more suited-determining an optimum signal processing network architecture. This arrangement is believed to be more efficient in certain cases than using genetic programming alone, e.g., using gene expression programming to determine both the architecture and accurate numerical parameters.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The inventionis defined solely by the appended claims including any amendments made during the pendency of this application and all equivalents of those claims as issued.

We claim:

1. A computer configured by software to:
generate an initial population including a plurality of representations of signal processing networks with variable numerical parameters;
for each of a succession of generations of said population derived from said initial population:
numerically optimize said variable numerical parameters for each signal processing network represented in said population;
check if a fitness goal has been achieved by one or more signal processing networks represented in said population;
if said fitness goal has been achieved:
output information relative to one or more signal processing networks that achieved said fitness goal;
if said fitness goal has not been achieved:
selectively replicate said plurality of representations for a next generation based on, at least, a fitness measure; and
perform evolutionary operations on said next generation.

2. The computer according to claim 1 further configured by software to:
check that each of said plurality of representations of signal processing networks encodes a valid signal processing network.

3. The computer according to claim 2, wherein said computer is configured by software to:
represent each signal processing network by a chromosome array, that includes gene elements that represent signal processing elements and one or more signal sources; and
wherein, in checking that each of said plurality of representations of signal processing networks encodes a valid signal processing network, said computer is programmed to:
read a maximum chromosome length;
set an index that points to successive gene elements to an initial value;
initialize a required gene variable;
until said required gene variable is equal to zero OR said index is equal to said maximum chromosome length:
increasing said required gene variable by one less than a number of inputs required for a signal processing element coded by a gene element identified by said index that points to successive gene elements; and
incrementing said index that points to successive gene elements;
after said required gene variable is equal to zero OR said index is equal to said maximum chromosome length, if said required gene variable is greater than zero, return an invalid chromosome indication.

4. The computer according to claim 1, wherein said computer is configured by software to:
represent each signal processing network by a chromosome array, that includes gene elements that represent signal processing elements and one or more signal sources; and
wherein, in checking if said fitness goal has been achieved, said computer is configured by software to:
decode each chromosome array to determine each signal processing network encoded in each chromosome array; and
simulate processing of a training data vector through each signal processing network.

5. The computer according to claim 4 wherein, in decoding each chromosome array to determine each signal processing network encoded in each chromosome array, said computer is configured by software to:
execute a recursive routine that comprises:
receive a chromosome including a sequence of genes representing signal processing elements, and terminals including signal inputs;
check if a first gene of said sequence of genes encodes a signal processing element, if said first gene does not encode a signal processing element terminating, and if said first gene does encode a signal processing element:
set a total number of children for said first gene to a number of inputs of said signal processing element;
initialize a first gene pointer to point to a second gene of said sequence following said first gene;
initialize a children counter at one;
associate said second gene with said first gene as a child of said first gene;
determine a length of a portion of said sequence of genes that encodes a sub-tree rooted by said child, wherein said sub-tree is part of a tree representation of the signal processing network;
recursively apply the recursive routine to said sequence of genes that encodes said sub-tree;
if said first gene has more children:
increment said children counter to indicate a next child;
set said first gene pointer to point to said next child in said sequence of genes which follows said portion of said sequence of genes; and
associate said next child with said first gene as a child of said first gene; and
return to said step of determining for said next child; and
If said first gene does not have more children, terminate.

6. The computer configured by software according to claim 5, wherein, in determining said length of said portion of said sequence of genes that encodes said sub-tree rooted by said child comprises, said computer is programmed to:
initialize a second gene pointer to point to said child;
initialize a required gene variable;
until the required gene variable is equal to zero;
increment the required gene variable by a number of signal inputs of a signal processing element coded by a current gene minus one;
increment the second pointer to point to a next gene; and
when said required gene variable is equal to zero, report said length that is based on said second gene pointer value.

7. The computer according to claim 5 wherein, in simulating processing of a training data vector through each signal processing network:
starting at said first gene of said sequence of genes that represents a root in said tree representation of said signal processing network, and recursively applying a procedure of:
evaluating each child gene of each gene; and
using vectors output by each child gene to evaluate said gene,
whereby, said training data vector is processed through said tree representation of said signal processing network to an output of said root in said tree representation.

8. The computer according to claim 1 wherein, in numerically optimizing said variable numerical parameters, said computer is configured by software to:
generate an initial population including a plurality of sets of numerical parameters to be used with each signal processing network;
for each of a succession of generations of said population of said plurality of sets of numerical parameters:
evaluate a measure of performance related fitness for each signal processing network when configured with each of said plurality of sets of numerical parameters;
checking, at least if a performance related fitness criteria has been satisfied;
if, at least, said performance related fitness criteria has not been satisfied:
selected a next generation of sets of numerical parameters, based at least in part on said performance related fitness;
perform evolutionary operations on said next generation of sets of numerical parameters;
if, at least, said performance related fitness criteria has been satisfied:
return a set of numerical parameters that yield a best performance.

9. The computer according to claim 8 wherein, in performing said evolutionary operations on said next generation of sets of numerical parameters, said computer is configured by software to:
perform differential evolution mutation.

10. The computer according to claim 1 wherein, in checking if said fitness goal has been achieved by one or more signal processing networks represented in said population, said computer is programmed by software to evaluate an overall fitness measure that includes a performance related fitness measure and a parsimony related fitness measure.

11. The computer according to claim 1, wherein said computer is configured by software to:
represent each signal processing network by a chromosome array, that includes gene elements that represent signal processing elements and one or more signal sources; and
in performing evolutionary operations on said next generation, said computer performs one or more evolutionary operations selected from a group consisting of one-point crossover two-point crossover, and mutation.

12. The computer according to claim 1, wherein, in generating an initial population including a plurality of representations of signal processing networks with variable numerical parameters, said computer is configured by software to generate representations of signal processing networks that include signal processing elements that have input-output relations that vary substantially in character as a function of said variable numerical parameters.

13. The computer according to claim 12 wherein said signal processing elements include a Q-filter that accepts a window of signal samples Sⱼ as input and produces a Q-filtered output.

14. The computer according to claim 13, wherein operation of said Q-filter is described by:
e=rₘᵢₙ+C
where,
e is a filtered signal sample,
rₘᵢₙ is a minimum of an ordered sequence of thresholds to which said input signal samples Sⱼ are compared wherein said ordered sequence of thresholds is represented as: rₒ<r₁< . . . <rₘ₋₁, wherein rₘᵢₙ=rₒ<=Sⱼ<=rₘ₋₁,=r_{max.}, wherein said input signal samples are bounded between said minimum rₘᵢₙ and a maximum threshold rₘₐₓ and wherein:
$$C = {\sum }_{i = 1}^{m - 1} {q}_{i} \frac{{r}_{max} - {r}_{min}}{m - 1} = \frac{{r}_{max} - {r}_{min}}{m - 1} {\sum }_{i = 1}^{m - 1} {q}_{i}$$
where
$${q}_{i} = \{ \begin{matrix} \frac{{\prod }_{j = 1}^{n} ( 1 + λ {h}_{ij} {f}^{j} ) - 1}{F} , & λ \geq - 1 , λ \neq 0 \\ \frac{{\sum }_{j = 1}^{n} {h}_{ij} {f}^{j}}{F} , & λ = 0\end{matrix}$$
where,
λ is a filter control parameter; and
$$F = \{ \begin{matrix}{\prod }_{j = 1}^{n} ( 1 + λ {f}^{j} ) - 1 , & λ \geq - 1 , λ \neq 0 \\ {\sum }_{j = 1}^{n} {f}^{j} , & λ = 0\end{matrix}$$
where,
f^{j} are a sequence of density parameters in the range [0,1], and
hᵢⱼ=1 for Sⱼ>=rᵢ and otherwise hᵢⱼ=0.

15. The computer according to claim 13 wherein said signal processing elements include a Q-aggregator.

16. The computer according to claim 13 wherein said signal processing elements include a scaler and a biaser.

17. The computer according to claim 12 wherein said signal processing elements include a fast Q-filter.

18. The computer according to claim 17 wherein said signal processing elements include a Q-aggregator.

19. The computer according to claim 17 wherein said signal processing elements include a scaler and a biaser.

20. The computer according to claim 17 wherein said fast Q-filter operates by:
receiving a window of input signal samples;
determining a magnitude ordering of said window of input signal samples according to magnitude;
computing a set of values by evaluating a recursion relation:
ψᵢ=f₍ᵢ₎+ψᵢ₊₁+λf₍ᵢ₎ψᵢ₊₁,i=n, . . . , 1
where,
ψₙ₊₁=0, and
f₍ᵢ₎ε[0,1] is an i^{th} filter parameter in an ordering of a set of filter parameters according to a set of permutations required to achieve said ordering of said window of signal samples;
normalizing said set of values by dividing each by a largest of said set of values thereby obtaining a set of Q-measures;
subtracting successive Q-measures to obtain a set of Q-measure differences:
$$Δ {q}_{i} = \frac{{ψ}_{i} - {ψ}_{i + 1}}{{ψ}_{1}} , i = 1 , … , n$$
computing a scalar product of said Q-measure differences and said window of signal samples wherein each ith Q-measure difference is multiplied by an ith signal sample in said magnitude ordering of said window of signal samples.

21. The computer according to claim 12 wherein said signal processing elements include a Q-aggregator.

22. The computer according to claim 21 wherein said Q-aggregator has an input-output relation described by:
$${h}_{λ} ( {a}_{1} , … , {a}_{n} ) = \{ \begin{matrix} \frac{{\prod }_{i = 1}^{n} ( 1 + λ {a}_{i} ) - 1}{{\prod }_{i = 1}^{n} ( 1 + λ ) - 1} & λ \geq - 1 , λ \neq 0 \\ \frac{1}{n} {\sum }_{i = 1}^{n} {a}_{i} & λ = 0\end{matrix}$$
where,
λ>=−1 is the control parameter that is used to configure said Q-aggregator;
aₖε[0,1] is a k^{th} input to said Q-aggregator;
n>1 is a number of inputs; and
h_{λ}(a₁, . . . ,aₙ)ε[0,1] is an output of said Q-aggregator.
